(19) United States
(12) Patent Application Publication
(10) Pub. No.: US 2023/0350395 A1
(43) Pub. Date: Nov. 2, 2023

(54) CHEMICAL PRODUCTION CONTROL

(71) Applicant: BASF SE, Ludwigshafen Am Rhein (DE)

(72) Inventors: Christian-Andreas Winkler, Ludwigshafen (DE); Hans Rudolph, Lemförde (DE); Michael Hartmann, Lemförde (DE); Markus Rautenstrauch, Lemförde (DE); Yuan En Huang, Changhua (TW); Sebastian Wandernoth, Ludwigshafen (DE); Nataliya Yakut, Ludwigshafen (DE)

(21) Appl. No.: 18/026,692

(22) PCT Filed: Sep. 16, 2021
(86) PCT No.: PCT/EP2021/075450

§ 371 Date: Mar. 16, 2023

(30) Foreign Application Priority Data
Sep. 18, 2020 (EP) 20197014.2
Oct. 27, 2020 (EP) 20204115.8

(51) Int. Cl. G05B 19/418

(52) U.S. Cl. CPC G05B 19/41875; G05B 2219/32368

(57) ABSTRACT

The present teachings relate to a method for controlling a production process, for manufacturing a chemical product, comprising: providing an upstream object identifier comprising input material data and at least one desired performance parameter related to the chemical product; determining a set of process and/or operation parameters based on the upstream object identifier and the at least one desired performance parameter; determining zone-specific control settings for each of the equipment zones based on the determined set of process and/or operation parameters and historical data; providing the zone-specific control settings for controlling the production of the chemical product related to the upstream object identifier. The present teachings also relate to a system for controlling a production process, a use of the control settings, and a software product for implementing the method steps disclosed herein.

### TECHNICAL FIELD

The present teachings relate generally to computer assisted chemical production.

### BACKGROUND ART

In industrial plants, input material is processed to manufacture one or more products. Properties of the manufactured product thus have a dependence upon manufacturing parameters. It is usually desired to correlate manufacturing parameters to at least some properties of the product for ensuring product quality or production stability.

Within process industry, or industrial plants such as chemical or biological production plants, one or more input materials are processed using a production process for producing one or more chemical or biological products. Production environment in the process industry can be complex, accordingly the properties of the product may vary according to variations in the production parameters that influence said properties. Usually the dependency of the properties on production parameters can be complex and intertwined with a further dependence on one or more combinations of specific parameters. In some cases, the production process may be divided into multiple stages, which can further aggravate the problem. It may thus be challenging to produce a chemical or biological product with consistent and/or predictable quality.

For keeping quality of the chemical product consistent, quality control may be performed. Quality control normally involves collecting one or more samples of the chemical product after or during the production process. The samples are then analyzed and then corrective action, as necessary, may be taken. Dependent upon the frequency of variations occurring in the that production process, the frequency of quality control may be required to be increased, which may not be practical. Moreover, such quality control may usually be expensive and time consuming. Thus, a plurality of similar chemical products produced at different times may have a statistical variation or tolerance range associated within which their properties or performance may lie. The size of the variation is usually dependent on the cost of producing the chemical product. For example, at a cheaper cost of production, a wider variation between a plurality of products may be needed to be accepted, and for a more consistent performance the cost of producing may be higher.

Further, in contrast to discrete processing, chemical or biological processing such as continuous, campaign or batch processes, may provide vast amounts of time series data.

However, machine learning via traditional time series approaches has proven to be less practical, since it can be difficult to integrate data according to the needs of horizontal integration across the value chain. In particular, easy and meaningful data exchange or standardization can pose major problems.

There is hence a need for approaches that can improve control and production stability across the value chain ideally from barrel to end product.

### SUMMARY

At least some of the problems inherent to the prior art will be shown solved by the subject matter of the accompanying independent claims. At least some of the further advantageous alternatives will be outlined in the dependent claims.

When viewed from a first perspective, there can be provided a method for controlling a production process for manufacturing a chemical product at an industrial plant, the industrial plant comprising a plurality of physically separated equipment zones, and the product being manufactured by processing, via the plurality equipment zones, at least one input material using the production process, the method at least partially being performed via a computing unit, which method comprises:
providing, via an interface, an upstream object identifier comprising input material data and at least one desired performance parameter related to the chemical product; wherein the input material data is indicative of one or more properties of the input material,
determining, via the computing unit, a set of process and/or operation parameters based on the upstream object identifier and the at least one desired performance parameter;
determining, via the computing unit, zone-specific control settings for each of the equipment zones based on the determined set of process and/or operation parameters and historical data;
providing, via an output interface, the zone-specific control settings for controlling the production of the chemical product related to the upstream object identifier.

The applicant has realized that by doing so, the at least one desired zone-specific performance parameter related to the desired quality of the chemical product may be used to control the way a specific input material with its associated properties is being processed in the upstream equipment zone and/or the zones downstream of the upstream equipment zone. Thus, by using the at least one desired performance parameter, the computing unit may determine the set of process and/or operation parameters required to achieve said at least one desired performance parameter for the input material, specifics of which are provided via the input material data. The set of process and/or operation parameters is then used to determine the zone-specific control settings, i.e., such control settings that the production process may be executed accordingly for achieving a desired performance or quality of the chemical product, said quality specified via the at least one desired performance parameter. Additionally, the historical data can be synergistically leveraged to find optimal control settings. The upstream object identifier may be provided, for example, when the input material is at an upstream equipment zone, or even earlier. The upstream object identifier may even be triggered by certain events or event signals such as zone location, some non-limiting examples of which will be discussed later.

Historical data may comprise past process data and/or quality control data associating at least one zone-specific control settings with at least one performance parameter, and/or associating at some of the process and/or operation parameters with at least one performance parameter. The at least one performance parameter may be obtained, for example, from quality control data such as lab analysis or result values.

According to an aspect, the historical data comprise data from one or more historical upstream object identifiers related to previously processed input material, and wherein at least one of the historical upstream object identifiers is appended with at least a part of that process data which is indicative of the process parameters and/or equipment operating conditions that the previously processed input material was processed under, for example, in the upstream equipment zone.

In some cases, the historical object identifiers may be from other upstream zones with similar production where past input material was processed, so such historical object identifiers from such zones may be usable.

Thus, a historical object identifier may not only encapsulate that part of the process data under which the respective previous input material was processed to produce or process the respective chemical product. The historical data as disclosed herein may thus be a highly relevant yet concise data set, which can be used for determining the zone-specific control settings for each of the equipment zones as a goal for achieving the desired performance as specified via the at least one desired performance parameter. The upstream object identifier may even be used as a historical object identifier for later production.

According to an aspect, each or some of the historical object identifiers include at least one zone-specific performance parameter related to the one or more properties of associated chemical product produced. Thus, each or some of the historical object identifiers are appended with, or it may provide, the at least one zone-specific performance parameter.

Thus, the object identifiers as proposed in context of the present teachings not only can improve the traceability of the chemical product, but also can be used to ensure that the production process is controlled in such a way as to obtain a more consistent quality of the chemical product. Rather than relying upon universal control settings, which can result in a wider variation in a plurality of chemical products manufactured at different times, the production chain or equipment zones can be controlled in a more adaptable manner with a goal to achieve a desired performance. Variability of input material and/or process parameters and/or equipment operating conditions can thus be at least partially accounted for while providing the zone-specific control settings for producing the chemical product.

So, the method also comprises:
executing, using the zone-specific control settings, the production process.

The production process may be executed by at least some of the zone-specific control settings the being entered at a plant control system operatively coupled to the equipment zones. Additionally, or alternatively, the production process may be executed by at least some of the zone-specific control settings the being automatically provided to the plant control system. The zone-specific control settings may be transmitted directly to the plant control system by the computing unit, or they may be provided at a memory location operatively coupled to the computing unit from which memory location the plant control system may read of fetch the control settings. In some cases, the computing system may at least partially be a part of the plant system such that the computing system may directly use the zone-specific control settings to at least partially control the production process. The zone-specific settings allow control of the production process at each of the zones. A finer granularity and flexibility of control can thus be achieving the performance of the chemical product according to the at least one desired performance parameter.

According to an aspect, the method further comprises:
receiving, at the computing unit, real-time process data from one or more of the equipment zones; wherein the real-time process data comprise real-time process parameters and/or equipment operating conditions.

The computing unit may thus be communicatively and/or operatively coupled to the equipment zones or equipment.

According to a further aspect, the method comprises:
determining, via the computing unit, a subset of the real-time process data based on the upstream object identifier and a zone presence signal; wherein the zone presence signal indicates presence of the input material at a specific equipment zone during the production process.

So, the subset of the real-time process data for the upstream equipment zone may be determined in response to the zone presence signal indicating the input material being at the upstream equipment zone. The computing unit is thus able to select the process data which is relevant for the upstream object identifier. Or, said relevant data, or the subset of real-time process data, may be selected based on where the material is located within the production chain, or by using the zone presence signal.

According to another aspect, the method comprises:
computing, via the computing unit, at least one zone-specific performance parameter of the chemical product related to the upstream object identifier based on the subset of the real-time process data and the historical data.

As it will be appreciated, the process data may not be entirely consistent and may have a variability associated with one or more of the components of the data. For example, two different batches of material that have been mixed with the same mixer at different times may have been mixed in non-identical manners. Similar variability may also exist with other parameters and/or operating conditions. The variability between individual components may be random and independent or partly independent of those of the other components. Furthermore, a combination of such variabilities and/or other interdependencies may result in a variability in the performance or quality of the chemical product. Thus, as specified above, dependent upon the subset of the real-time process data, the computing unit may be configured to compute the at least one zone-specific performance. So, the at least one zone-specific performance parameter indicative of the quality of the chemical product may be determined essentially while the input material is being processed in the upstream equipment zone. The at least one zone-specific performance parameter and/or its deviation from the corresponding desired performance parameter may be displayed for an operator, for example, via a human machine interface (“HMI”). The operator may then adjust the production process such that each or some of the at least one zone-specific performance parameter can be the same value as, or it becomes closer to, its associated value of the desired performance parameter.

Alternatively, or in addition, the method comprises:
appending, to the upstream object identifier, the at least one zone-specific performance parameter.

The zone-specific performance parameter may be appended for example as metadata to the upstream object identifier. So, the upstream object identifier also encapsulates the at least one zone-specific performance parameter computed during the production process. Thus, it not only can improve the traceability of the chemical product, but also simplify the quality control for the chemical product. The upstream object identifier can even be used later as a historical object identifier which can provide insight of the performance obtained via a particular input material.

Alternatively, or in addition, the method comprises:
controlling, via the computing unit, the production process such that a difference between at least one of the zone-specific performance parameters and their respective value of the desired performance parameter is minimized.

The computed performance value can thus track the desired performance parameter value such the difference between the at least one of the zone-specific performance parameters that their respective or associated desired performance parameter value is minimized. Hence, granularity of control of the production process can be further improved at a finer scale. Such a control can allow at least partially accounting for variability in the various process parameters and/or operating conditions. Potentially, each of the equipment zones may be controlled automatically such that the resulting chemical products can have a more consistent performance or quality.

Alternatively, or in addition, the method comprises:
appending, to the upstream object identifier, the subset of real-time process data.

Thus, the relevant part of the real-time process data may also be captured and packaged or encapsulated with the input material data in the upstream object identifier such that any relationship of the chemical product with the properties of the input material are also be captured in a traceable manner. This can provide a more complete relationship between the various dependencies those may influence any one or more properties or performance of the chemical product. Another advantage can be that the combination between the various interdependencies that may exist between the input material properties and/or the process parameters are also captured within the upstream object identifier. The upstream object identifier is thus enriched with information that can be used not only for tracking the chemical product and/or its specific components such the input material, but also the specific real-time process data that were responsible for resulting in the chemical product. As a result, the object identifiers such as each of the historical object identifiers can be more easily integrated for any machine learning (“ML”) and such purposes. As already discussed, the upstream object identifier can also be used as a historical object identifier for future production which in such cases can provide insight of the performance obtained when a particular input material is processed under specific process conditions specified via the subset of real-time process data.

It will be appreciated that the desired performance parameter may either be related directly to one or more properties of the chemical product and/or it may be related to one or more properties of a derivative material that is produced during the production process. For example, in cases where the input material is transformed to a derivative material during the course of the production process, it may sometimes be required to track and/or control the quality or performance of such derivative material as well. It will be understood that in such cases the derivative material is an intermediate material resulting from the input material, which derivative material is then used to produce the chemical product. Since the chemical product is also dependent upon the derivative material, it may sometimes be required to track and control the derivative material as well.

Thus, according to an aspect, at least one of the desired performance parameters is related to one or more properties of the derivative material.

According to an aspect, the zone presence signal may be generated via the computing unit by performing a zone-time transformation, which maps at least one property related to the input material to the specific equipment zone. For example, the property related to the input material may be the weight of the input material, such that by a knowledge of the production process, e.g., via the real-time process data, the presence of the input material or its derivative material produced during the production process can be determined. As an example, if an input material with a certain weight in the upstream equipment zone traverses during the production process to a downstream equipment zone, a weight measurement at the downstream zone, e.g., at or within a pre-determined time, can be used to generate a zone presence signal for the downstream zone. Similarly, a flow value, e.g., mass flow or volume flow, by which the input material or its derivative material traverses through the production can be a property is used for generating the zone presence signal. Further as an example, the speed or velocity by which the input material traverses along the equipment zones can be used to determine the space or location where the input material or its corresponding derivative material is at a given time. Alternatively, or in addition, other non-limiting example of the property related to the input material are, volume, fill value, level, color, etc.

The applicant has found it advantageous to generate the zone presence signal by mapping the real-time process data, which in a production environment is time-dependent data, e.g., time-series data, to spatial data thus mapping the real-life production flow using digital flow element representing the input material. For example, digital flow of the input material can be tracked via the upstream object identifier and occurrences in the time-dependent real-time process data can be used for locating the material along the production process. The material is thus tracked or located via the time and real-time process data which is already measured, i.e., by using the time dimension of the process data, which correlates to the time dimension of the flow of the input material along the production chain.

The zone presence signal may be intermittent, for example generated via computing at regular or irregular times, or it may be continuously generated. This can have an advantage that the material associated with the respective object identifier can be continuously or essentially continuously located within the production chain and thus enabling the appending of data which are highly relevant for the material and its transformation to the chemical product. The computation at regular or irregular times may for example be done to check the presence of the material at certain checkpoints within the production chain. This may be supplemented by occurrences in the real-time process data, for example, by one or more sensors as outlines below.

Since in chemical production operation parameters relating to the time dimension, like dwell times and flow velocities are known, the zone-time transformation can be a simple mapping in time scales. Alternatively, a more complex model based on process simulations may be used for matching the time scales of material flow and the real-time process data. In any case the time scale of process-data may be finer than the flow of the material so as to attribute the process data parameters more finely to the flow of the material.

Thus, the subset of the real-time process data or even the components thereof, such as each or some of the process parameters and/or equipment operating conditions can be further optimized or made more concise according to the time that the material spends at specific sub-parts of the equipment zone. For example, if an equipment zone such as the upstream equipment zone comprises a mixer, followed by a heater, then the subset of the real-time data may comprise the process parameters and/or equipment operating conditions related to the mixer only for the time that the input material was at the mixer. Similarly, the process parameters and/or equipment operating conditions related to the heater may only be included from the time that the material was exposed to the heater, for example upon exiting from the mixer. That way the relevance of the dataset can be further minutely managed and optimized according to the relevance for the specific material. An alternative, as would be understood, may be that the subset of process data comprises all of the process parameters and/or equipment operating conditions related to the upstream equipment zone from the time the input material enters the upstream equipment zone and until the time the input material leaves the upstream equipment zone, this alternative already has an advantage of providing high relevance data for the upstream object identifier, however by further specifying the individual components of the process data as explained, within the zone itself, the subset of real-time process data can be further optimized and the relevance of data encapsulated within the respective object identifier can be further improved.

Additionally, or alternatively, the zone presence signal may be provided at least partially via a sensor related to a specific zone. For example, a weight sensor and/or image sensor may be used to detect the presence of the input material or the derivative material at a space or in a specific equipment zone.

“Equipment” may refer to any one or more assets within the industrial plant. As non-limiting examples, the equipment may refer to any one or more, or any of their combination of, computing units or controllers such as programmable logic controller (“PLC”) or distributed control system (“DOS”), sensors, actuators, end effector units, transport elements such as conveyor systems, heat exchangers such as heaters, furnaces, cooling units, distilling units, extractors, reactors, mixers, millers, choppers, compressors, slicers, extruders, dryers, sprayers, pressure or vacuum chambers, tubes, bins, silos and any other kind of apparatus which is used directly or indirectly for or during production in the industrial plant. Preferably, the equipment refers specifically to those assets, apparatuses or components which are involved directly or indirectly in the production process. More preferably, those assets, apparatuses or components which can influence the performance of the chemical product. An equipment may be buffered or they may be unbuffered. Moreover, the equipment may involve mixing or no mixing, separation or no separation. Some non-limiting examples of unbuffered equipment without mixing are, conveyor system or belt, extruder, pelletizer, and heat exchanger. Some non-limiting examples of buffered equipment without mixing are, buffer silo, bins, etc. Some non-limiting examples of buffered equipment with mixing are, silo with mixer, mixing vessel, cutting mill, double cone blender, curing tube, etc. Some non-limiting examples of unbuffered equipment with mixing are, static or dynamic mixer, etc. Some non-limiting examples of buffered equipment with separation are, column, separator, extraction, thin film vaporizer, filter, sieve, etc. The equipment may even be or it may include a storage or packaging element such as, octabin filling, drum, bag, tank truck. Sometimes, a combination of two or more pieces of equipment may also be considered as an equipment.

“Equipment zones” refer to physically separated zones that are either a part of the same piece of equipment, or the zones may be different pieces of equipment that is used for manufacturing the chemical product. The zones are thus physically located at non-identical locations. The locations may be non-identical geographical locations laterally and/or vertically. The input material thus starts from an upstream equipment zone and traverses downstream, towards one or more equipment zones that are downstream of the upstream equipment zone. Various steps of the production process may thus be distributed between the zones.

In present disclosure, the terms “equipment” and “equipment zones” may be used inter changeably.

“Equipment operating conditions” refers to any characteristics or values that represent the state of the equipment, for example of a specific zone, for example, any one or more of, setpoint, controller output, production sequence, calibration status, any equipment related warning, vibration measurement, speed, temperature, fouling value such as filter differential pressure, maintenance date, etc.

The term “upstream” shall be understood as being in the direction opposite to the flow of production. For example, the very first equipment zone where the production process starts is an upstream equipment zone. The term is, however, used in a relative sense within its meaning in the present disclosure. For example, an intermediate equipment zone that lies between the first equipment zone and the last equipment zone may also be called an upstream zone for the last equipment zone, and a “downstream” equipment zone for the first equipment zone. The last equipment zone is thus a downstream zone for the first equipment zone and for the intermediate equipment zone. Similarly, both the first equipment zone and the intermediate equipment zone are upstream of the last equipment zone.

“Industrial plant” or “plant” may refer, without limitation, to any technical infrastructure that is used for an industrial purpose of manufacturing, producing or processing of one or more industrial products, i.e., a manufacturing or production process or a processing performed by the industrial plant. The industrial product can, for example, be any physical product, such as a chemical, a biological, a pharmaceutical, a food, a beverage, a textile, a metal, a plastic, a semiconductor. Additionally, or alternatively, the industrial product can even be a service product, for example, recovery or waste treatment such as recycling, chemical treatment such as breakdown or dissolution into one or more chemical products. Accordingly, the industrial plant may be one or more of a chemical plant, a process plant, a pharmaceutical plant, a fossil fuel processing facility such as an oil and/or a natural gas well, a refinery, a petrochemical plant, a cracking plant, and the like. The industrial plant can even be any of a distillery, a treatment plant, or a recycling plant. The industrial plant can even be a combination of any of the examples given above or their likes.

The infrastructure may comprise equipment or process units such as any one or more of a heat exchanger, a column such as a fractionating column, a furnace, a reaction chamber, a cracking unit, a storage tank, an extruder, a pelletizer, a precipitator, a blender, a mixer, a cutter, a curing tube, a vaporizer, a filter, a sieve, a pipeline, a stack, a filter, a valve, an actuator, a mill, a transformer, a conveying system, a circuit breaker, a machinery e.g., a heavy duty rotating equipment such as a turbine, a generator, a pulverizer, a compressor, an industrial fan, a pump, a transport element such as a conveyor system, a motor, etc. Sometimes a combination of two or more of these may also be considered an equipment.

Further, an industrial plant typically comprises a plurality of sensors and at least one control system for controlling at least one parameter related to the process, or process parameter, in the plant. Such control functions are usually performed by the control system or controller in response to at least one measurement signal from at least one of the sensors. The controller or control system of the plant may be implemented as a distributed control system (“DCS”) and/or a programmable logic controller (“PLC”).

Thus, at least some of the equipment or process units of the industrial plant may be monitored and/or controlled for producing one or more of the industrial products. The monitoring and/or controlling may even be done for optimizing the production of the one or more products. The equipment or process units may be monitored and/or controlled via a controller, such as DCS, in response to one or more signals from one or more sensors. In addition, the plant may even comprise at least one programmable logic controller (“PLC”) for controlling some of the processes. The industrial plant may typically comprise a plurality of sensors which may be distributed in the industrial plant for monitoring and/or controlling purposes. Such sensors may generate a large amount of data. The sensors may or may not be considered a part of the equipment. As such, production, such as chemical and/or service production, can be a data heavy environment. Accordingly, each industrial plant may produce a large amount of process related data.

Those skilled in the art will appreciate that the industrial plant usually may comprise instrumentation that can include different types of sensors. Sensors may be used for measuring one or more process parameters and/or for measuring equipment operating conditions or parameters related to the equipment or the process units. For example, sensors may be used for measuring a process parameter such as a flowrate within a pipeline, a level inside a tank, a temperature of a furnace, a chemical composition of a gas, etc., and some sensors can be used for measuring vibration of a pulverizer, a speed of a fan, an opening of a valve, a corrosion of a pipeline, a voltage across a transformer, etc. The difference between these sensors cannot only be based on the parameter that they sense, but it may even be the sensing principle that the respective sensor uses. Some examples of sensors based on the parameter that they sense may comprise: temperature sensors, pressure sensors, radiation sensors such as light sensors, flow sensors, vibration sensors, displacement sensors and chemical sensors, such as those for detecting a specific matter such as a gas. Examples of sensors that differ in terms of the sensing principle that they employ may for example be: piezoelectric sensors, piezoresistive sensors, thermocouples, impedance sensors such as capacitive sensors and resistive sensors, and so forth.

The industrial plant may even be part of a plurality of industrial plants. The term “plurality of industrial plants” as used herein is a broad term and is to be given its ordinary and customary meaning to a person of ordinary skill in the art and is not to be limited to a special or customized meaning. The term specifically may refer, without limitation, to a compound of at least two industrial plants having at least one common industrial purpose. Specifically, the plurality of industrial plants may comprise at least two, at least five, at least ten or even more industrial plants being physically and/or chemically coupled. The plurality of industrial plants may be coupled such that the industrial plants forming the plurality of industrial plants may share one or more of their value chains, educts and/or products. The plurality of industrial plants may also be referred to as a compound, a compound site, a Verbund or a Verbund site. Further, the value chain production of the plurality of industrial plants via various intermediate products to an end product may be decentralized in various locations, such as in various industrial plants, or integrated in the Verbund site or a chemical park. Such Verbund sites or chemical parks may be or may comprise one or more industrial plants, where products manufactured in the at least one industrial plant can serve as a feedstock for another industrial plant.

“Production process” refers to any industrial process which when, used on, or applied to the input material provides the chemical product. The chemical product is thus provided by transforming the input material either directly, or via one or more derivative materials, via the production process to result in the chemical product. The production process can thus be any manufacturing or treatment process involving at least partially one or more chemical processes or a combination of a plurality of processes that are used for obtaining the chemical product. The production process may even include packaging and/or stacking of the chemical product. The production process may thus be a combination of chemical and physical processes.

The terms “to manufacture”, “to produce” or “to process” will be used interchangeably in the context of the production process. The terms may encompass any kind of application of an industrial process including a chemical process to the input material that results in one or more chemical products.

“Chemical product” in this disclosure may refer to any industrial product, such as chemical, pharmaceutical, nutritional, cosmetic, or biological product, or even any of their combination. The chemical product may be either consist entirely of natural components, or it may at least partially comprise one or more synthetic components. Some non-limiting examples of the chemical product are, organic or inorganic compositions, monomers, polymers, foams, pesticides, herbicides, fertilizers, feed, nutrition products, precursors, pharmaceuticals or treatment products, or any one or more of their components or active ingredients. In some cases, the chemical product may even be a product usable by an end-user or consumer, for example, a cosmetic or pharmaceutical composition. The chemical product may even be a product that is usable for making further one or more products, for example, the chemical product may be a synthetic foam usable for manufacturing soles for shoes, or a coating usable for automobile exterior. The chemical product may be in any form, for example, in the form of solid, semi-solid, paste, liquid, emulsion, solution, pellets, granules, beads, particles such as thermoplastic polyurethane (“TPU”) or expanded thermoplastic polyurethane (“ETPU”) particles, or powder.

As such chemical products can be difficult to trace or track especially during their production process. During production, material such as the input material may be mixed with other material, and/or the input material may be split in different parts down the production chain, for example, for processing in different ways. The input material may be transformed more than once, for example to one or more derivative materials before being transformed to the chemical product. Sometimes, the chemical product may be split and packaged in different packages. Although in some cases it may be possible to label the packaged chemical product or its portions, it may be hard to attach the specifics of the production process which were responsible for producing that specific chemical product or its portions. In many cases, the input material and/or the chemical product may be in a form where it is difficult to label them physically. The present teachings thus provide ways in which one or more object identifiers can also be used for overcoming such limitations.

The production process may be continuous, in campaigns, for example, when based on catalysts which require recovery, it may be a batch chemical production process. One main difference between these production types is in the frequencies occurring in the data that is generated during production. For example, in a batch process the production data extends from start of the production process to the last batch over different batches that have been produced in that run. In a continues setting, the data is more continuous with potential shifts in operation of the production and/or with maintenance driven down times.

“Process data” refers to data comprising values, for example, numerical or binary signal values, measured during the production process, for example, via the one or more sensors.

The process data may be time-series data of one or more of the process parameters and/or the equipment operating conditions. Preferably, the process data comprises temporal information of the process parameters and/or the equipment operating conditions, e.g., the data contains time stamps for at least some of the data points related to the process parameters and/or the equipment operating conditions. More preferably, the process data comprises time-space data, i.e., temporal data and the location or data related to one or more equipment zones that are located physically apart, such that time-space relationship can be derived from the data. The time-space relationship can be used, for example for computing the location of the input material at a given time.

“Real-time process data” refers to the process data that is measured or is in a transient state essentially while a specific input material is being processed using the production process. For example, the real-time process data for the input material is the process data from or around the same time as the processing of the input material using the production process. Here, around the same time means with little or no time delay. The term “real-time” is understood in the technical field of computers and instrumentation. As a specific non-limiting example, a time delay between a production occurrence during the production process being performed on the input material and the process data being measured or read-out is less than 15 s, specifically of no more than 10 s, more specifically of no more than 5 s. For high throughput processing the delay is less than a second, or less than a couple of milliseconds, or even. The real-time data can thus be understood as a stream of time-dependent process data being generated during the processing of the input material.

“Process parameters” may refer to any of the production process related variables, for example any one or more of, temperature, pressure, time, level, etc.

“Input material” may refer to at least one feedstock or unprocessed material that is used for producing the chemical product. The input material may be any organic or inorganic substance or even their combination. Thus, the input material may even be a mixture or it may comprise a plurality of organic and/or inorganic components in any form. In some cases, the input material may even be a derivative material or an intermediate processed material, for example as received or transferred from an upstream equipment zone. A few non-limiting examples of the input material can be any one or more of: polyether alcohol, polyether diol, polytetrahydrofuran, polyester diol such as based on adipic acid and butane-1,4-diol, isocyanates, filler material—either organic or inorganic material such as wood powder, starch, flax, hemp, ramie, jute, sisal, cotton, cellulose or aramid fibers, silicates, barite, glass spheres, zeolites, metals or metal oxides, talc, chalk, kaolin, aluminum hydroxide, magnesium hydroxide, aluminum nitrite, aluminum silicate, barium sulfate, calcium carbonate, calcium sulfate, silica, quartz powder, aerosil, clay, mica or wollastonite, iron powder, glass spheres, glass fibers or carbon fibers.

As a further non-limiting example, the input material may be methylene diphenyl diisocyanate (“MDI”) and/or polytetrahydrofuran (“PTHF”) which is subjected to at least a part of the production process to obtain a thermoplastic polyurethane. It will be appreciated that the input material is thus chemically processed in one or more equipment zones to obtain the thermoplastic polyurethane, which may in some cases be a derivative material. The derivative material is further processed for obtaining a chemical product. For example, the thermoplastic polyurethane may be further processed in one or more further equipment zones to obtain an expanded thermoplastic polyurethane. The expanded thermoplastic polyurethane may, for example, be the chemical product. In some cases, however, the thermoplastic polyurethane itself may even be the chemical product which is sent to a downstream customer or facility for further processing.

“Input material data” refers to data related to one or more characteristics or properties of the input material. Accordingly, the input material data may comprise any one or more of the values indicative of properties, such as quantity, of the input material. Alternatively, or in addition, the value indicative of the quantity may be fill degree and/or mass flow of the input material. The values are preferably measured via one or more sensors operatively coupled to or included in the equipment. Alternatively, or in addition, the input material data may comprise sample/test data related to the input material. Alternatively, or in addition, the input material data may comprise values indicative of any physical and/or chemical characteristics of the input material, such as any one or more of, density, concentration, purity, pH, composition, viscosity, temperature, weight, volume, etc. In cases when the upstream equipment zone is downstream of a previous equipment zone, the input material data may comprise a part of data from the object identifier of the previous equipment zone, for example, the input material data may then comprise a reference or link to the object identifier of the previous zone or even in some cases at least a part of the process data from the previous object identifier.

It has to be mentioned that the input material being processed by the processing equipment of an underlying chemical production environment is divided into physical or real-world packages, in the following called “package objects” (or “physical packages” or “product packages”, respectively). The package size of such package objects can be fixed, e.g. by material weight or by material amount, or can be determined based on a weight or amount, for which considerably constant process parameters or equipment operation parameters can be provided by the processing equipment. Such package objects can be created from an input liquid and/or solid raw material by means of a dosing unit.

The subsequent processing of such package objects is managed by means of corresponding data objects which include so-called “Object identifiers”, which are assigned to each package object via a computing unit being coupled with the mentioned equipment, or even being a part of the equipment. The data objects, including the corresponding “Object identifiers” of an underlying package object, are stored at a memory storage element of the computing unit.

The data objects can be generated in response to a trigger signal being provided via the equip-ment, preferably in response to the output of a corresponding sensor being arranged at each of an equipment unit. As mentioned above, an underlying industrial plant may include different types of sensors, e.g. sensors for measuring one or more process parameters and/or for measuring equipment operating conditions or parameters related to the equipment or the process units.

A mentioned “Object identifier”, more particularly, refers to a digital identifier for its respective input material. For example, the upstream object identifier is provided for the input material. Similarly, a historical upstream object identifier corresponds to a specific historical input material that was processed earlier. The object identifier is preferably generated by a computing unit. The providing or generation of the object identifier may be triggered by the equipment, or in response to a trigger event or signal, for example from the upstream equipment zone. The object identifier is stored in a memory storage element operatively coupled to the computing unit. The memory storage may comprise, or it may be a part of, at least one database. Accordingly, the object identifier may even be a part of the database. It will be appreciated that the object identifier may be provided via any suitable manner, such as it may be transmitted, received or it may be generated.

“Computing unit” may comprise, or it may be, a processing means or computer processor such as a microprocessor, microcontroller, or their like, having one or more processing cores. In some cases, the computing unit may at least partially be a part of the equipment, for example it may be a process controller such as programmable logic controller (“PLC”) or a distributed control system (“DCS”), and/or it may be at least partially be a remote server. Accordingly, the computing unit may receive one or more input signals from one or more sensors operatively connected to the equipment. If the computing unit is not a part of the equipment, it may receive one or more input signals from the equipment. Alternatively, or in addition, the computing unit may control one or more actuators or switches operatively coupled to the equipment. The one or more actuators or switches operatively may even be a part of the equipment.

“Memory storage” may refer to a device for storage of information, in the form of data, in a suitable storage medium. Preferably, the memory storage is a digital storage suitable for storing the information in a digital form which is machine-readable, for example digital data that are readable via a computer processor. The memory storage may thus be realized as a digital memory storage device that is readable by a computer processor. The memory storage may at least partially be implemented in a cloud service. Further preferably, the memory storage on the digital memory storage device may also be manipulated via a computer processor. For example, any part of the data recorded on the digital memory storage device may be written and/or erased and/or overwritten, partially or wholly, with new data by the computer processor.

“Computing unit” may comprise, or it may be, a processing means or computer processor such as a microprocessor, microcontroller, or their like, having one or more processing cores. In some cases, the computing unit may at least partially be a part of the equipment, for example it may be a process controller such as programmable logic controller (“PLC”) or a distributed control system (“DCS”), and/or it may be at least partially be a remote server and/or cloud service. Accordingly, the computing unit may receive one or more input signals from one or more sensors operatively connected to the equipment or the plurality of equipment zones. If the computing unit is not a part of the equipment, it may receive one or more input signals from the equipment or equipment zones. Alternatively, or in addition, the computing unit may control one or more actuators or switches operatively coupled to the equipment. The one or more actuators or switches operatively may even be a part of the equipment. The computing unit is operatively coupled to the equipment or the plurality of equipment zones.

Accordingly, the computing unit may be able to manipulate one or more parameters related to the production process by controlling any one or more of the actuators or switches and/or end effector units, for example via manipulating one or more of the equipment operating conditions. The controlling is preferably done in response to the one or more signals retrieved from the equipment.

“End effector unit” or “end effector” in this context refers to a device that is either a part of the equipment and/or is operatively connected to the equipment, and hence controllable via the equipment and/or the computing unit, with a purpose to interact with the environment around the equipment. As a few non-limiting examples, the end effector may be a cutter, gripper, sprayer, mixing unit, extruder tip, or their likes, or even their respective parts that are designed to interact with the environment, for example, the input material and/or the chemical product.

“Property” or “properties” when it comes to the input material, may refer to any one or more of quantity of the input material, batch information, one or more values specifying quality such as purity, concentration, viscosity, or any characteristic of the input material.

“Interface” may be a hardware and/or a software component, either at least partially a part of the equipment, or a part of another computing unit where the object identifier is provided. For example, the interface may be an application programming interface (“API”). In some cases, the interface may also connect to at least one network, for example, for interfacing two pieces of hardware components and/or protocol layers in the network. For example, the interface may be an interface between the equipment and the computing unit. In some cases, the equipment may be communicatively coupled to the computing unit via the network. Thus, the interface may even be a network interface, or it may comprise the network interface. In some cases, the interface may even be a connectivity interface, or it may comprise the connectivity interface.

“Output interface” and the interface may refer to the same component, or they may be different components. Similar to as was discussed regarding the interface, also the output interface may be a hardware and/or a software component, either at least partially a part of the equipment, or a part of another computing unit where the object identifier is provided. For example, the output interface may be an application programming interface (“API”). In some cases, the output interface may also connect to at least one network, for example, for interfacing two pieces of hardware components and/or protocol layers in the network. For example, the output interface may be an interface between the equipment and the computing unit. The output interface may even be a network interface, or it may comprise the network interface. In some cases, the output interface may even be a connectivity interface, or it may comprise the connectivity interface.

“Network interface” refers to a device or a group of one or more hardware and/or software components that allow an operative connection with the network.

“Connectivity interface” refers to a software and/or hardware interface for establishing communication such as transfer or exchange or signals or data. The communication may either be wired, or it may be wireless. Connectivity interface is preferably based on or it supports one or more communication protocols. The communication protocol may a wireless protocol, for example: short distance communication protocol such as Bluetooth®, or WiFi, or long communication protocol such as cellular or mobile network, for example, second-generation cellular network or (“2G”), 3G, 4G, Long-Term Evolution (“LTE”), or 5G. Alternatively, or in addition, the connectivity interface may even be based on a proprietary short distance or long distance protocol. The connectivity interface may support any one or more standards and/or proprietary protocols. The connectivity interface and the network interface may either be the same unit or they may be different units.

“Network” discussed herein may be any suitable kind of data transmission medium, wired, wireless, or their combination. A specific kind of network is not limiting to the scope or generality of the present teachings. The network can hence refer to any suitable arbitrary interconnection between at least one communication endpoint to another communication endpoint. Network may comprise one or more distribution points, routers or other types of communication hardware. The interconnection of the network may be formed by means of physically hard wiring, optical and/or wireless radio-frequency methods. The network specifically may be or may comprise a physical network fully or partially made by hardwiring, such as a fiber-optical network or a network fully or partially made by electrically conductive cables or a combination thereof. The network may at least partially comprise the internet.

As it was discussed that in some cases, the respective subset of process data is appended to the object identifier. For example, either the subset of real-time process data which the input material is processed by the upstream equipment zone is included in the upstream object identifier in its entirely, or a part thereof is appended or saved. Thus, a snapshot of the real-time process data that was relevant for processing the input material in the upstream equipment zone is made available or linked with the upstream object identifier. Whether the real-time process data is saved in its entirety, or a part thereof may, for example, be based on a determination via the computing unit regarding which part of subset of process data should be appended to the object identifier.

Alternatively, or in addition, to what was discussed previously, or in addition, the determination may, for example, be done based upon most dominant the process parameters and/or equipment operating conditions than have influence on the desired properties of the chemical product. This can be advantageous in certain cases, especially when the relevant real-time process data is large in volume, so rather than appending a large amount of data, to the upstream object identifier, the computing unit may determine which of the subset of the real-time process data is to be appended. Hence, the part of the real-time process data appended to the object identifier may be determined via the computing unit. Furthermore, the determination can be based upon one or more ML models. Such models will be discussed in more detail following in this disclosure.

According to further an aspect, the upstream object identifier is also appended with process specific data. data may comprise. The process specific data may be any one or more of, enterprise resource planning (“ERP”) data, such as an order number and/or production code and/or production process recipe and/or batch data, recipient data, and a digital model related to the transformation of the input material to the chemical product. The ERP data may be received from an ERP system related to the industrial plant. The digital model may be any one or more of: a computer readable mathematical model representing one or more physical and/or chemical changes that are related to the transformation of the input material to the chemical product. The recipient data may for example be data related to one or more customer orders and/or specifications. The batch data may be related to the batch under production and/or data related to the previous products manufactured via the same equipment. By doing so, traceability of the chemical product can be further improved by bundling the associated process specific data. More specifically, the batch data can be used to more optimally sequence the production of chemical products that are produced at least partially via the same equipment, but which chemical products have one or more different properties or specifications. For example, the production of such chemical products can then be adjusted and/or sequenced in such a manner that a subsequent batch is least affected due to its prior batch. For example, if two or more chemical products are of different colors, then the sequence of their production may be determined via the computing unit such that the later manufactured product is least affected due to the prior manufactured chemical product in terms to traces of color from the previous product.

“Control settings” refer to any controllable settings and/or values that can be influenced by one or more plant control systems that are functionally or operatively coupled to the equipment zones in such a manner that the settings and/or controllable values influence the manner in which the input material, and if relevant derivative material, is processed to produce the chemical product. So, control settings determine process parameters and/or operating conditions using which the derivative material and/or chemical product is produced. For example, a control setting may be a set-point for one or more controllers in the one or more plant control system. The control setting may, for example, relate to a temperature set-point that a controller should use for processing at an equipment zone. Another control setting may be a time period for which one or more materials should be mixed. Other non-limiting examples of control settings are values such as: time, pressure, amount such as weight or volume, ratio, level, rate of change such as flow rate, speed, and mass. Additionally, or alternatively, the control settings may even determine the recipe with which the chemical product is produced. For example, at least some of the zone-specific control settings may determine material amounts or percentage to be used, for example choosing in what ratio two components should be mixed and/or additive dosing amount.

“Zone-specific control settings” thus refer the control settings, i.e., any controllable settings and/or values, which are specific to a particular zone, for example, for the upstream equipment zone.

“Performance parameter” may be, or it may be indicative of or related to, any one or more properties of the chemical product. Accordingly, the performance parameter is such a parameter that should satisfy one or more predefined criteria indicating suitability, or a degree of suitability, of the chemical product for a particular application or use. It will be appreciated that in certain cases, the performance parameter may indicate a lack of suitability, or a degree of unsuitability, for a particular application or use of the chemical product. As nonlimiting examples, the performance parameter may be any one or more of, strength such as tensile strength, hardness such as Shore hardness, density such as bulk density, color, concentration, composition, viscosity, melt flow value (“MFV”), stiffness such as Young's modulus value, purity or impurity such as parts per million (“ppm”) value, failure rate such as mean time to failure (“MTTF”), or any one or more values or value ranges, for example determined via tests using the predefined criteria. The performance parameter is thus representative of the performance or quality of the chemical product. The predefined criteria may, for example, be one or more reference values or ranges with respect to which the performance parameter of the chemical product is compared to, for determining the quality or performance of the chemical product. The predefined criteria may have been determined using one or more tests such as lab tests, reliability or wear tests, thus defining the requirements on the performance parameter for the chemical product to be suitable for one or more particular uses or applications. In some cases, the performance parameter may be related to or measured from the properties of a derivative material.

“Desired performance parameter” may be, or it may be indicative of or related to, any one or more desired properties of the chemical product. So, the desired performance parameter may correspond to a desired value of the performance parameter.

It will be appreciated that “zone-specific” in the present context refers to pertaining to a specific equipment zone, for example the upstream equipment zone.

Usually, the performance parameters are determined from one or more samples of the chemical product and/or the derivative material collected during and/or after production. The samples may be brought to a laboratory and analyzed for determining the performance parameters. The results of the analysis, or the determined performance parameters may be included or appended to the respective object identifier, and hence included in the historical data.

However, it will be appreciated that the whole activity of collecting samples, processing or testing them, and then analyzing the test results can take significant time and resources. There can thus be a significant delay between collecting of the samples and implementing any adjustments in the input material and/or process parameters and/or equipment operating conditions. This delay or lag may either result in sub-optimal chemical products being produced, or in the worst case, the production is halted until the samples have been analyzed and any corrective action by adjusting the input material and/or process parameters and/or equipment operating conditions has been undertaken.

As a solution to at least reducing the variability in the performance of the chemical product, the present teachings can be used to more tightly control the production process via the historical data, and in some cases via the at least one zone-specific performance parameter that may be appended to at least some of the historical object identifiers. The need for manual sampling can thus be reduced.

According to an aspect, the computing of at least one zone-specific performance parameter is done using a model, which is at least partly an analytical computer model. Additionally, or alternatively, the model may at least partly be one or more machine learning (“ML”) models.

Additionally, or alternatively, the determining of the zone-specific control settings is done using either the model or an another model. Similar to the model, the another model may at least partly an analytical computer model. The another model may thus also at least partially be one or more machine learning (“ML”) models. The ML model may be trained using the historical data, e.g., from the one or more historical upstream object identifiers.

In the context of the present teachings, an ML model may be, or it may comprise, a prediction model that when trained using the historical data may result in a data driven model. “Data driven model” refers to a model that is at least partially derived from data, in this case from historical data. In contrast to a rigorous model that is purely derived using physio-chemical laws, a data driven model can allow describing relations that cannot be modelled by physio-chemical laws. The use of data driven models can allow to describe relations without solving equations from physio-chemical laws. This can reduce computational power and/or improve speed.

The data driven model may be a regression model. The data driven model may be a mathematical model. The mathematical model may describe the relation between provided performance properties and determined performance properties as a function.

Thus, in the present context, the data-driven model, preferably data-driven machine learning (“ML”) model or a merely data-driven model, refers to a trained mathematical model that is parametrized according to the respective training data set, such as upstream historical data or downstream historical data, to reflect reaction kinetics or physio-chemical processes related to the respective production process. An untrained mathematical model refers to a model that does not reflect reaction kinetics or physio-chemical processes, e.g. the untrained mathematical model is not derived from physical law providing a scientific generalization based upon empirical observation. Hence, the kinetic or physio-chemical properties may not be inherent to the untrained mathematical model. The untrained model does not reflect such properties. Feature engineering and training with the respective training data sets enable parametrization of the untrained mathematical model. The result of such training is a merely data-driven model, preferably data-driven ML model, which as a result of the training process, preferably solely as a result of the training process, reflects reaction kinetics or physio-chemical processes related to the production process.

The model and/or the another model may even be a hybrid model. The hybrid model may refer to a model that comprises first-principles parts, the analytical model or so called white box, as well as data-driven parts as explained previously, so called black box. The model may comprise a combination of a white-box-model and a black-box-model and/or a grey-box-model. The white-box-model may be based on physio-chemical laws. The physiochemical laws may be derived from first principles. The physio-chemical laws may comprise one or more of chemical kinetics, conservation laws of mass, momentum and energy, particle population in arbitrary dimension. The white-box-model may be selected according to the physio-chemical laws that govern the respective production process or parts thereof. The black-box-model may be based on the historical data, for example from one or more historical object identifiers. The black-box-model may be built by using one or more of machine learning, deep learning, neural networks, or other form of artificial intelligence. The black-box-model may be any model that yields a good fit between the training data set and test data. The grey-box-model is a model that combines a partial theoretical structure with data to complete the model.

As used herein, the term “machine learning” or “ML” may refer to a statistical method that enables machines to “learn” tasks from data without explicitly programming. Machine learning techniques may comprise “traditional machine learning”—the workflow in which one manually selects features and then trains the model. Examples of traditional machine learning techniques may include decision trees, support vector machines, and ensemble methods. In some examples, the data driven model may comprises a data driven deep learning model. Deep learning is a subset of machine learning modeled loosely on the neural pathways of the human brain. Deep refers to the multiple layers between the input and output layers. In deep learning, the algorithm automatically learns what features are useful. Examples of deep learning techniques may include convolutional neural networks (“CNNs”), recurrent neural networks such as long short-term memory (“LSTM”), and deep Q networks.

In the present disclosure, the terms “ML model” and “trained ML model” may be used interchangeably. Although it will be indicated or it will be clear for the persons skilled in the art, which kind of data the particular ML model has been trained with to be able to perform the intended function.

Chemical production can be a data heavy environment, which produces lots of data from different equipment. It will also be appreciated that the teachings as proposed also make the realization of a monitoring and/or control method or system suitable and more efficient for edge computing in an industrial plant, especially a chemical plant. Monitoring such as safety and/or quality control and/or control of the production process can thus be done essentially on the spot, for example within each zone, with reduced computational resources such as processing power and/or memory requirements as the object identifiers provide highly targeted data sets of relevant data for computation of the performance parameter. It may also be possible to reduce latency in the computation, thus making sure that there is enough time for number crunching algorithms without slowing down the production process. It can also make the training process for the ML models faster and more efficient.

Due to similar reasons, it also makes the present teachings suitable for cloud-computing because datasets can be made compact and efficient. Many cloud service providers operate with a pay-per-use model based on the utilization of the computational resources, so costs can be reduced and/or the computational power can be more efficiently utilized.

Thus, according to an aspect, at least one ML model, such as those discussed above, may be trained based on the data from the one or more historical upstream object identifiers, or the historical data to result in a data-driven model. The data used for training the ML model may also include historical and/or current laboratory test data, or data such as performance parameters measured from the past and/or recent samples of the chemical product and/or the derivative material. For example, quality data from one or more analyses such as image analysis, laboratory equipment or other measurement techniques may be used. By including the analyzed performance parameters in their associated historical object identifiers, a more complete relationship between the performance parameters and their corresponding process data is captured in an efficient manner. The costly and time-consuming lab results can thus be more accurately leveraged to improve the quality of the future chemical products. Scope of human error can also be reduced because the quality data is integrated with its associated snapshot of process data. In some cases, a sampling object identifier is automatically provided if the chemical product or a derivative material is to be analyzed. This may be bases upon a confidence value or if the computing unit cannot minimize the difference between a computed performance parameter and its corresponding desired value. The analysis results done on the sample can thus be included or appended at the sampling object identifier, further reducing the scope of human error. The data from the sampling object identifier can also be included in the historical data.

The at least one ML model trained with the data from historical upstream object identifiers can thus be used for determining at least some of the zone-specific control settings.

Thus, for determining the zone-specific control settings the ML model which is trained using the historical data may receive as an input, the input material data and the at least one desired performance parameter. The trained ML model or the data-driven model can thus provide the zone-specific control settings as computed values. As was discussed previously, the computed values may be provided to an operator via an HMI and/or the values may be provided directly to the control system. Also similar to as was discussed, the trained ML model can be used for automatically adapting the production process according to the specifics of the input material obtained from the input material data, and the desired performance obtained from the at least one desired performance parameter, and the subset of real-time process data. The computing unit can for example, minimize the difference between each or some of the zone-specific performance parameters, computed via the trained ML model, and their respective desired performance parameter value.

According to another aspect, the trained ML model may also provide at least one confidence value indicative of the zone-specific control settings. In some cases, the confidence value may also be appended to the upstream object identifier, for example as metadata. Should the confidence level of the prediction or computation of any of the zone-specific control settings fall below an accuracy threshold value, a warning may be triggered at the control system for production. The warning may be generated as a warning signal, for example to initiate production using a set of default setting it may be used to determine if the ML model should be retrained.

In some cases, in response to the confidence level of the prediction or computation of any of the zone-specific control settings falling below the accuracy threshold value, a retraining object identifier is automatically provided via the interface. The processing unit may append the confidence value, the input material data and the at least one desired performance parameter to the retraining object identifier. The retraining object identifier may be used to determine which insights are lacking for controlling the production process with the set of variables included in the retraining object identifier. The retraining object identifier can thus be used to further improve the historical data for future determinations via the computing unit. According to an aspect, the chemical product produced associated with the retraining object identifier may be sampled and analyzed. The results of the analysis, for example, measured performance parameters may be appended to the retraining object identifier. The retraining object identifier can thus be included for generating the historical data. This way, full traceability of the material can be maintained, and correct product can be sampled such that the historical data is efficiently enriched even for the cases that were not fully covered with the previous historical data. So, this can allow the correct one or more samples to be collected from production due to tracking provided by the retraining object identifier, and the samples may be analyzed together with the data from the retraining object identifier to find the cause of fall in the confidence level. Complex relationships between various variables can thus be better understood such that control process can be improved further.

In some cases, the same ML model or an another one, may be used by the computing unit for determining which of part or components of the subset of the real-time process data have most dominant effect on the chemical product. Accordingly, the computing unit is enabled to exclude those of the process parameters and/or equipment operating conditions which have negligible effect on the at least one zone-specific performance parameter. Relevance of the real-time process data that is appended for specific chemical products can hence be improved for their respective object identifier.

According to an aspect, the plurality of physically separated equipment zones also comprises a downstream equipment zone such that during manufacturing or production process the input material progresses from the upstream equipment zone to the downstream equipment zone. In some cases, the input material may be divided or reduced prior to reaching the downstream equipment zone. Thus, according to further an aspect, a downstream object identifier is provided for at least a part of the input material at the downstream equipment zone. The downstream object identifier is appended with at least a part of the upstream object identifier. So, either the entire upstream object identifier may be encapsulated in the downstream object identifier, or just a part thereof. The part may be, for example a reference to the upstream object identifier, or a link which ties the two object identifiers either directly or via one or more other object identifiers that may have been generated for zones between the upstream equipment zone and the downstream equipment zone.

It will also be appreciated that in some cases, the at least a part of the input material may be called the derivative material. Similar to as it was discussed, the zone presence signal may be used to detect or compute when the input material or derivative material is at the downstream equipment zone such that the computing unit may determine further zone-specific control settings at least for the downstream equipment zone. The further zone-specific control settings may even be generated for other zones that are downstream of the downstream equipment zone. The further zone-specific control settings may be generated based on the data from the upstream object identifier and/or data from an intermediate object identifier which relates to an intermediate equipment zone between the upstream equipment zone and the downstream equipment zone. For example, the at least one zone-specific performance parameter computed by the upstream object identifier can be used. Thus, the production process can be adapted in the downstream zones according to the process data that the material was processed with at the upstream zones. Granularity of the control can thus be further improved and be made more flexible. For example, any suboptimal processing upstream can be corrected by adapting the downstream zone-specific control settings.

Thus, the method may also comprise:
providing, via the interface, a downstream object identifier comprising at least a reference to the upstream object identifier;
determining, via the computing unit, an another subset of the real-time process data based on the downstream object identifier and the zone presence signal;
determining, via the computing unit, further zone-specific control settings for at least the downstream equipment zone based on data from the upstream object identifier, the another subset of the real-time process data and another historical data.

According to an aspect, the another historical data comprise data from one or more historical downstream object identifiers related to previously processed input material, for example, in the downstream equipment zone. According to another aspect, at least one of the historical downstream object identifiers has been appended with at least a part of the process data which is indicative of the process parameters and/or equipment operating conditions that the previously processed input material was processed under in the downstream equipment zone.

In addition to determining the further zone-specific control settings, the downstream object identifier can thus appended with at least a part of the real-time process data from the downstream equipment zone. The downstream object identifier may at least partially encapsulate or be enriched with, the upstream object identifier, or more specifically the data from the upstream object identifier which has been appended with at least a part of the subset of the real-time process data. Alternatively, the downstream object identifier may be linked to the upstream object identifier. In other words, the downstream object identifier is appended with the upstream object identifier. The downstream object identifier and the upstream object identifier may either be located at the same location, or they may be located at different locations. Thus, the downstream object identifier is related to the upstream object identifier either by the upstream object identifier being at least partially being a part of the downstream object identifier.

The computing unit may also compute an another at least one zone-specific performance parameter of the chemical product related to the downstream identifier based on the another subset of the real-time process data and another historical data. The downstream object identifier may even be appended with the another at least one zone-specific performance parameter.

Thus, the method may also comprise:
computing, via the computing unit, another at least one zone-specific performance parameter of the chemical product related to the downstream object identifier based on the another subset of the real-time process data and the another historical data.
appending, to the downstream object identifier, the another at least one zone-specific performance parameter.

Furthermore, as it was discussed previously, the method may also comprise:
appending, to the downstream object identifier, at least a part of the another subset of the real-time process data.

By doing this, finer visibility into the quality of various components of the production chain can be improved. For example, the performance parameters of each specific zones can also be used to track and control the quality of the material in that specific zone.

Similar to the above discussion pertaining to the upstream equipment zone, the models, such as at least partially an ML model as discussed herein can also be applied to the downstream equipment zone. Some examples for the same are listed below.

For example, according to an aspect, at least one downstream ML model, such as the ones discussed previously, may be trained based on the data from the one or more historical downstream object identifiers. The data used for training the downstream ML model may also include historical and/or current laboratory test data, or data from the past and/or recent samples of the chemical product and/or the derivative material. For example, quality data from one or more analyses such as image analysis, laboratory equipment or other measurement techniques may be used.

The at least one ML model trained with the data from historical downstream object identifiers can thus be used for predicting the zone-specific control settings for that zone and also the other zones downstream. Also, optionally one or more of the zone-specific performance parameters related to the chemical product may be predicted. At least some of the sampling and testing requirements can thus be removed, thus saving time and resources.

For the latter case, for computing the at least one zone-specific performance parameter the downstream ML model which is trained using the historical downstream data may receive as an input, at least a part of the subset of the downstream real-time process data. The downstream ML model can thus provide the at least one zone-specific performance parameter as computed value. Thus, such a downstream ML model can also be used together with the ML model for upstream equipment zone for monitoring and/or controlling the production process by adapting the control settings thus addressing any quality control issues more finely at an early stage.

Similarly, the downstream ML model may also provide at least one downstream confidence value indicative of the confidence level for the at least one zone-specific performance parameter and/or the further zone-specific control settings. The downstream confidence value may also be appended to the downstream object identifier, for example as metadata. Should the confidence level of the prediction or computation of at least one zone-specific performance parameter and/or the further zone-specific control settings fall below their corresponding accuracy threshold value, a warning may be triggered at the control system for production. The warning may be generated as a warning signal, for example to initiate a physical test of a sample for lab analysis.

Those skilled in the art will appreciate that the terms “appending” or “to append” may mean including or attaching, for example saving different data elements such as metadata in the same database, or in the same memory storage element, either in adjacent or at different locations in the database or memory storage. The term may even mean linking, of one or more data elements, packages or streams at the same or different locations, in such a manner that the data packages or streams can be read and/or fetched and/or combined when needed. At least one of the locations may be a part of a remote server or even at least partially a part of a cloud-based service.

“Remote server” refers to one or more computers or one or more computer servers that are located away from the plant. The remote server may thus be located several kilometers or more from the plant. The remote server may even be located in a different country. The remote server may even be at least partially implemented as a cloud based service or platform, for example as platform as a service (“PaaS”). The term may even refer collectively to more than one computers or servers located on different locations. The remote server may be a data management system.

It will be appreciated that the input material after traversing through the upstream equipment zone may be substantially different in nature from the time when the input material entered the upstream equipment zone. Hence, as discussed, at entry of the input material at the downstream zone, the input material may have transformed to a derivative material or an intermediate processed material. However, for the sake of simplicity, and without losing generality of the present teachings, the term input material will be used to refer also to the case when the input material during production process has converted to such an intermediate processed material or derivative material. For example, a batch of input material in the form of a mixture of chemical components may have traversed through the upstream zone on a conveyor belt where the batch is heated to induce a chemical reaction. As a result, when the input material enters the downstream zone, directly after exiting the upstream zone or after traversing also other zones, the material may have become a derivative material different in properties from the input material. However, as mentioned above, such derivative material can still be termed as the input material, at least because the relationship between such an intermediate processed material and the input material can be defined and determined via the production process. Moreover, in other cases, the input material may still essentially retain similar properties even after traversing the upstream zone or also other zones, for example when the upstream zone simply dries the input material or filters it to remove traces of an unwanted material. Hence, those skilled in the art will understand that the input material in intermediate zones may or may not be transformed to a derivative material.

In some cases, there may be one or more intermediate zones between the upstream zone and the downstream zone, but no separate object identifier is provided for such zones. The applicant has found it more advantageous to generate the downstream object identifier when the input material, or derivative material, is combined with other material, or when the input material, or derivative material, is divided or fragmented into multiple parts. Or more generally, after providing the object identifier, generation of a downstream object identifier or any further object identifiers may be done only at those zones where the material mass flow changes. Mass flow change may be a change in mass which is a result of adding or mixing of new material to the input material or the derivative material and/or removal or division of material from the input material or the intermediate processed material. Changes in mass, for example, due to removal of moisture or due to release of gasses caused by a chemical reaction during production in some cases may be excluded from occurrences which trigger the second or further object identifiers. Especially in a zone when there is no substantial change in the input material's mass, a further object identifier may not be provided. It is not essential here to specify a limit for “a substantial change” in mass because those skilled in the art will appreciate that it may depend, amongst other factors, upon the type of input material and/or chemical product being manufactured. For example, in some cases, a change in mass of 20% or more may be considered substantial, while in others 5% or more, or in some cases 1% or more, or perhaps even a lower % value. For instance, in cases of a precious product, a smaller change may be considered significant as compared to another product which is less precious.

As some examples, a determination of providing or generation of the object identifier at an equipment zone after the upstream equipment zone may be based upon any of; not providing a new object identifier if backmixing degree at the equipment zone is smaller than or nearly the size of the package at the zone preceding said equipment zone, providing a new object identifier if backmixing degree at the equipment zone is larger than the size of the package at the zone preceding said equipment zone, not providing a new object identifier at the equipment zone which is just a transport zone involving one or more transport systems or elements, providing a new object identifier for one or more components if the equipment zone involves separation of the material at said zone and the one or more components being the separated components of the material, providing at least one new object identifier at the equipment zone if it involves filling or packaging of the material into at least one package, each package comprising one or more chemical products.

As discusses, in case samples of input material, derivative material or the chemical product are collected for analysis, such samples may also be provided with a sample object identifier. The sample object identifier can be similar to the object identifiers discussed in the present disclosure and thus appended relevant corresponding process data as discussed. Thus, the samples can also be attached with an accurate snapshot of the production process that is relevant for the properties of said sample. The analysis and quality control can thus be further improved. Furthermore, the production process can be synergistically improved, e.g., based on improved training of one or more ML models.

According to another aspect, when the production process involves the input material being physically transported or moved in a zone or between zones, for example, using a transport element such as a conveyor system, the real-time process data may also include data indicative of the speed of the transport element and/or speed by which the input material is transported during the production process. The speed may be provided directly via one or more of the sensors and/or it may be calculated via the computing unit, for example, based on the time of entry at the zone and the time of exit from the zone or the time of entry at another zone subsequent to the zone. The object identifier can thus be further enriched with processing time aspects in the zone, especially those which may have impact on one or more performance parameters of the chemical product. Moreover, by using the time stamps of entry and exit or a subsequent zone entry, requirement of a speed measuring sensor or device for the transport element can be obviated.

According to another aspect, each object identifier includes a unique identifier, preferably a globally unique identifier (“GUID”). At least tracing of the chemical product may be enhanced by attaching the GUID to each virtual package of the chemical product. Via the GUID, data management of process data such as time-series data can also be decreased and a direct correlation between the virtual/physical package, the production history, and the quality control history can be enabled.

As discussed regarding ML models, according to an aspect, an upstream ML model, such as those discussed herein, may be trained based on the data from the upstream object identifier. The training data may also include past and/or current laboratory test data, or data from the past and/or recent samples of the derivative material and/or the chemical product. Furthermore, a downstream ML model, such as regression or deep learning model, may be trained based on the data from the downstream object identifier. The training data may also include past and/or current laboratory test data, or data from the past and/or recent samples of the derivative material and/or the chemical product.

In addition to the previously discussed advantages with the ML model, having the trained models based on zones in the production line can allow more detailed tracking of material and forecasting their respective performance parameters and even the chemical product performance parameters.

In some production scenarios like batch production such models may be used on the fly to flag quality control issues not only for the chemical product as produced, but also for any derivative materials.

Thus, any or each of the equipment zones may be monitored and/or controlled via an individual ML model, the individual ML model being trained based on data from the respective object identifier from that zone.

According to an aspect, providing of the respective object identifier for a zone may occur, or be triggered, in response to any one or more of the values indicative of properties of the input material and/or any one or more of the values from the equipment operating conditions and/or any one or more of the values of the process parameters reaching, meeting, or crossing a predefined threshold value. Any such values may be measured via one or more the sensors and/or switches. For example, the predefined threshold can be related to a weight value of the input material introduced at the equipment. Accordingly, when quantity such as the weight of the input material being received at the equipment reaches a predefined quantity threshold such as a weight threshold, a trigger signal may be generated. Certain examples of triggering events or occurrences for providing object identifiers were also discussed earlier in the present disclosure. In response to the trigger signal, or directly in response to the quantity or weight reaching the predefined weight threshold, the object identifier may be provided. The trigger signal can either be a separate signal, or it may just be an event, e.g., a particular signal meeting a predefined criteria such as threshold detected via the computing unit and/or the equipment. Thus, it will also be appreciated that, the object identifier may be provided in response to the quantity of the input material reaching a predefined quantity threshold. The quantity may be measured as weight as explained in the example above, and/or it may be any one or more other values such as level, fill or filling degree or volume and/or by summing up or by applying integration on the mass flow of the input material.

Thus, for example, the upstream object identifier may be provided in response to a trigger event or signal, said event or signal preferably being provided via the equipment or the upstream equipment zone. This may be done in response to output of any of the one or more sensors and/or switches operatively coupled to the upstream equipment. The trigger event or signal may relate to a quantity value of the input material, for example, to an occurrence of the quantity value reaching or meeting a predetermined quantity threshold value. Said occurrence may be detected via the computing unit and/or the upstream equipment, for example, using one or more weight sensor, level sensor, fill sensor, or any suitable sensor that can measure or detect the quantity of the input material.

An advantage of using quantity as a trigger for providing the upstream object identifier can be that any changes in the quantity of the material during the production process can be used as triggers for providing further one or more object identifiers as explained in the present teachings. The applicant has realized that this can provide an optimal way to segment generation of different object identifiers in an industrial environment for processing or producing one or more chemical products such that the input material, any derivative material, and eventually the chemical product can be traced while accounting for quantity or mass flow, essentially throughout the whole production chain and at least in some cases also beyond. By providing object identifiers just at points where new material is introduced or is inputted, or where the material is split, the number of object identifiers can be minimized while retaining traceability of the material not only at the end points of production, but also within. Within equipment or production zones where no new material is added, or where no material is split, knowledge of the processes within such zones can be used to maintain observability within two adjacent object identifiers.

When viewed from another perspective, there can also be provided a use of the zone-specific control settings, as generated in any of the method aspects discussed herein, for controlling a production process of an industrial plant.

Using the zone-specific control settings, the industrial plant can benefit from the advantages as herein disclosed.

When viewed from another perspective, there can also be provided a system for controlling a production process, the system being configured to perform any of the methods herein disclosed. Or, a system for controlling a production process for manufacturing a chemical product at an industrial plant, the industrial plant comprising a plurality of physically separated equipment zones, and the product being manufactured by processing, via the plurality equipment zones, at least one input material using the production process, wherein the system is configured to perform any of the methods herein disclosed.

For example, there can be provided a system for controlling a production process for manufacturing a chemical product at an industrial plant, the industrial plant comprising a computing unit and a plurality of physically separated equipment zones, and the product being manufactured by processing, via the plurality equipment zones, at least one input material using the production process, wherein the system is configured to:
provide, via an interface, an upstream object identifier comprising input material data and at least one desired performance parameter related to the chemical product; wherein the input material data is indicative of one or more properties of the input material,
determine, via the computing unit, a set of process and/or operation parameters based on the upstream object identifier and the at least one desired performance parameter;
determine, via the computing unit, zone-specific control settings for each of the equipment zones based on the determined set of process and/or operation parameters and historical data;
provide, via an output interface, the zone-specific control settings for controlling the production of the chemical product related to the upstream object identifier.

As discussed, the output interface and the interface may be the same component, or they may be different components, identical or non-identical to each other.

When viewed from another perspective, there can also be provided a computer program comprising instructions which, when the program is executed by a suitable computing unit, cause the computing unit to carry out any of the methods herein disclosed. There can also be provided a non-transitory computer readable medium storing a program causing a suitable computing unit to execute any method steps herein disclosed.

For example, there can be provided a computer program, or a non-transitory computer readable medium storing the program, comprising instructions which, when the program is executed by a suitable computing unit, operatively coupled to a plurality of for equipment zones for manufacturing a chemical product at an industrial plant by processing least one input material using a production process, causes the computing unit to:
provide, via an interface, an upstream object identifier comprising input material data and at least one desired performance parameter related to the chemical product;
wherein the input material data is indicative of one or more properties of the input material,
determine a set of process and/or operation parameters based on the upstream object identifier and the at least one desired performance parameter;
determine zone-specific control settings for each of the equipment zones based on the determined set of process and/or operation parameters and historical data;
provide, via an output interface, the zone-specific control settings for controlling the production of the chemical product related to the upstream object identifier.

It will be appreciated that the computing unit may be operatively coupled to the interface and/or the interface may be a part of the computing unit.

A computer-readable data medium or carrier includes any suitable data storage device on which is stored one or more sets of instructions (e.g., software) embodying any one or more of the methodologies or functions described herein. The instructions may also reside, completely or at least partially, within the main memory and/or within the processor during execution thereof by the computing unit, main memory, and processing device, which may constitute computer-readable storage media. The instructions may further be transmitted or received over a network via a network interface device.

The computer program for implementing one or more of the embodiments described herein may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network.

Furthermore, a data carrier or a data storage medium for making a computer program product available for downloading can be also provided, which computer program product is arranged to perform a method according to any of the aspects herein disclosed.

When viewed from another perspective, there can also be provided a computing unit comprising the computer program code for carrying out the method herein disclosed. Also, there can be provided a computing unit operatively coupled to a memory storage comprising the computer program code for carrying out the method herein disclosed.

That two or more components are “operatively” coupled or connected shall be clear to those skilled in the art. In a non-limiting manner, this means that there may at least be a communicative connection between the coupled or connected components e.g., via the interface or any other suitable interface. The communicative connection may either be fixed it or it may be removable. Moreover, the communicative connection may either be unidirectional, or it may be bidirectional. Furthermore, the communicative connection may be wired and/or wireless. In some cases, the communicative connection may also be used for providing control signals.

“Parameter” in this context refers to any relevant physical or chemical characteristic and/or a measure thereof, such as temperature, direction, position, quantity, density, weight, color, moisture, speed, acceleration, rate of change, pressure, force, distance, pH, concentration and composition. The parameter may also refer to a presence or lack thereof of a certain characteristic.

“Actuator” refers to any component of that is responsible for moving and controlling a mechanism related to an equipment such as a machine, directly or indirectly. The actuator may be a valve, motor, a drive, or their likes. The actuator may be operable electrically, hydraulically, pneumatically, or any of their combination.

“Computer processor” refers to an arbitrary logic circuitry configured for performing basic operations of a computer or system, and/or, generally, to a device which is configured for performing calculations or logic operations. In particular, the processing means or computer processor may be configured for processing basic instructions that drive the computer or system. As an example, the processing means or computer processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processing means or computer processor may be a multicore processor. Specifically, the processing means or computer processor may be or may comprise a Central Processing Unit (“CPU”). The processing means or computer processor may be a (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processing means or processor may also refer to one or more processing devices, such as a distributed system of processing devices located across multiple computer systems (e.g., cloud computing), and is not limited to a single device unless otherwise specified.

“Computer-readable data medium” or carrier includes any suitable data storage device or computer readable memory on which is stored one or more sets of instructions (e.g., software) embodying any one or more of the methodologies or functions described herein. The instructions may also reside, completely or at least partially, within the main memory and/or within the processor during execution thereof by the computing unit, main memory, and processing device, which may constitute computer-readable storage media. The instructions may further be transmitted or received over a network via a network interface device.

### BRIEF DESCRIPTION OF THE SEVERAL VIEWS OF THE DRAWINGS

Certain aspects of the present teachings will now be discussed with reference to the following drawings that explain the said aspects by the way of examples. Since the generality of the present teachings is not dependent on it, the drawings may not be to scale. Certain features shown in the drawings can be logical features that are shown together with physical features for sake of understanding and without affecting the generality of the present teachings. To easily identify the discussion of any particular element or act, the most significant digit or digits in a reference number refer to the figure number in which that element is first introduced.

FIG. 1 illustrates certain aspects of a system according to the present teachings.

FIG. 2 illustrates a method aspect in accordance with the present teachings.

FIG. 3 shows a first embodiment of a system and corresponding method according to the present teachings, by way of a combined block/flow diagram.

FIG. 4 shows a second embodiment of a system and corresponding method according to the present teachings, by way of a combined block/flow diagram.

FIG. 5 shows a third embodiment of a system and corresponding method according to the present teachings, by way of a combined block/flow diagram.

FIG. 6 shows a first embodiment of a graph-based database arrangement representing the topological structure of an industrial plant, or cluster of plants, including a plurality of equipment devices and according plurality of equipment zones between which the input material progresses during the manufacturing or production process.

FIG. 7 shows a second embodiment of a graph-based database arrangement as shown in FIG. 6.

FIG. 8 shows another embodiment of a system and corresponding method according to the present teachings using a cloud computing platform, by way of a combined block/flow diagram, where a machine learning (ML) process is implemented in the cloud.

### DETAILED DESCRIPTION

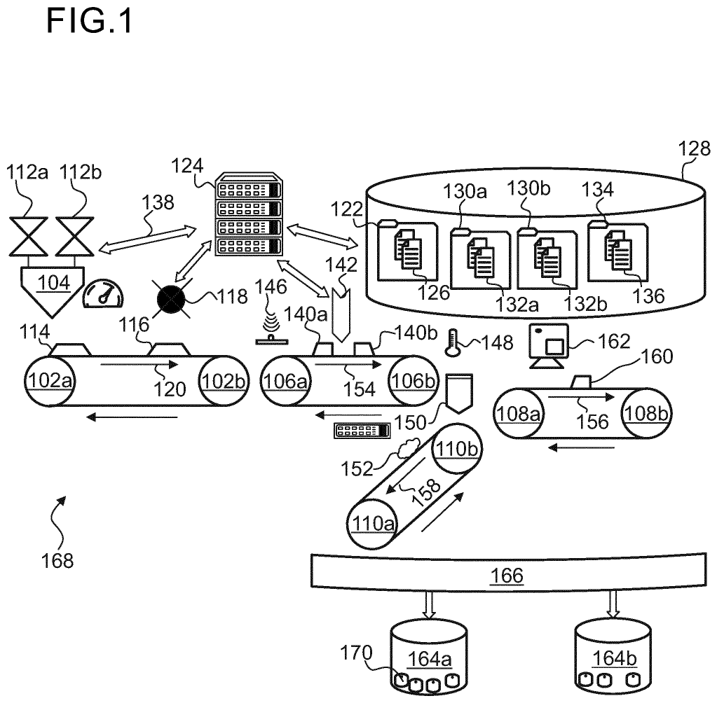

FIG. 1 shows an example of a system 168 for controlling a production process for manufacturing a chemical product 170 an industrial plant. At least some of the method aspects will also be understood from the following discussion. The industrial plant comprises at least one equipment or a plurality of equipment zones for manufacturing or producing the chemical product 170 using the production process. The chemical product 170 may in any form, for example, a pharmaceutical product, a foam, a nutritional product, an agricultural product, or a precursor. For example, the chemical product 170 may be a thermoplastic polyurethane in granular form. The chemical product 170 may even be in batches, for example a package of 10 kg each. As it was discussed, due to the nature of such chemical products, they may be hard to trace in the production chain. However, it may be important to ensure that each component, e.g., each unit or package, or even parts inside have consistent and desired properties or quality. The present teachings can enable production that can result in desired performance parameters to be achieved for the chemical product 170.

The equipment zones are shown in FIG. 1 as equipment, for example, as a hopper or mixing pot 104, which may be a part of an upstream equipment zone. The mixing pot 104 receives input material, which may be a single material, or it may comprise multiple components, for example, methylene diphenyl diisocyanate (“MDI”) and/or polytetrahydrofuran (“PTHF”). Here, the input material is received in two parts, which are shown supplied to the mixing pot 104 via a first valve 112a and a second valve 112b respectively. The first valve 112a and a second valve 112b may also belong to the upstream equipment zone.

An object identifier, or in this case, an upstream object identifier 122 is provided for the input material 114. The upstream object identifier 122 may be a unique identifier, preferably a globally unique identifier (“GUID”), distinguishable from other object identifiers. The GUID may be provided dependent upon the specifics of the particular industrial plant and/or the specifics of the chemical product 170 being manufactured and/or specifics of the date and time, and/or specifics of the particular input material being used. The upstream object identifier 122 is shown provided at a memory storage 128. The memory storage 128 is operatively coupled to a computing unit 124. The memory storage 128 may even be a part of the computing unit 124. The memory storage 128 and/or the computing unit 124 may at least partially be a part of a cloud service.

The computing unit 124 is operatively coupled to the upstream equipment zone or the equipment belonging to the upstream equipment zone, for example, via a network 138, which may be any suitable kind of data transmission medium. The computing unit 124 may even be a part of the equipment in the plant, for example it may be at least partially be a part of the upstream equipment zone. The computing unit 124 may even be at least partially a plant control system, such as a DCS and/or PLC. The computing unit 124 may receive one or more signals from one or more sensors operatively coupled to the equipment of the upstream equipment zone. For example, the computing unit 124 may receive one or more signals from a fill sensor 144 and/or one or more sensors related to the transport elements 102a-b. Said sensors are also a part of the upstream equipment zone. The computing unit 124 may even at least partially to control the upstream equipment zone, or some parts thereof. For example, the computing unit 124 may control the valves 112a,b, e.g., via their respective actuators, and/or a heater 118 and/or the transport elements 102a-b. The transport elements 102a,b and others in the example of FIG. 1 are shown as a conveyor system that may comprise one or more motors and a belt driven via said motors such that it moves such that the input material 114 via the belt is transported in the direction of transverse 120 of the belt.

Without affecting the scope or generality of the present teachings, other kinds of transport elements can also be usable instead or in combination with a conveyor system. In some cases, any kind of equipment that involves a flow of material, e.g., one or more materials in and one or more materials out, may be termed a transport element. Thus, besides a conveyor system or belt, equipment such as extruder, pelletizer, heat exchanger, buffer silo, silo with mixer, mixer, mixing vessel, cutting mill, double cone blender, curing tube, column, separator, extraction, thin film vaporizer, filter, sieve may also be termed transport elements. Thus, it will be appreciated that presence of a transport system as a conveyor system may be optional, at least because in some cases material may move directly from one equipment to another via mass flow, or as normal flow via one equipment to another. For example, a material may move directly from a heat exchanger to a separator or even further such as to a column and so forth. Thus, in some cases, one or more transport elements or system may be inherent to an equipment.

The upstream object identifier 122 may be provided in response to a trigger signal or event, which may be a signal or an event related to a quantity of the input material. For example, the fill sensor 144 may be used to detect at least one quantity value such as fill degree and/or weight of the input material. When the quantity reaches a predetermined threshold, the computing unit 124 may automatically provide the first upstream object identifier 122 at the memory storage 128. The upstream object identifier 122 comprises data related to the input material, or input material data. The input material data is indicative of one or more property of the input material.

The upstream object identifier 122 is also provided with at least one desired performance parameter (shown optionally as a subset of real-time process data 126, as will be discussed later) related to the chemical product 170. The desired performance parameter relates to desired performance or quality of the chemical product 170.

The computing unit 124 is then configured to determine a set of process and/or operation parameters based on the upstream object identifier 122 and the at least one desired performance parameter. The computing unit 124 can thus determine zone-specific control settings for each of the equipment zones based on the determined set of process and/or operation parameters and historical data. The historical data may comprise data from one or more historical upstream object identifiers related to previously processed input material, e.g., in the upstream equipment zone, and wherein each historical upstream object identifier is appended with at least a part of the process data which is indicative of the process parameters and/or equipment operating conditions that the previously processed input material was processed under in the upstream equipment zone. The zone-specific control settings are then provided for controlling the production process of the chemical product 170. The zone-specific control settings may be provided via an output interface, which may be the same as the interface, or a different component. The zone-specific control settings are thus used by the computing unit 124 and/or the plant control system for manufacturing the chemical product 170.

In some cases, the computing unit 124 may receive process data from all equipment or equipment zones in the industrial plant. The computing unit 124 may determine a subset of the real-time process data based on the upstream object identifier and a zone presence signal. For example, the trigger signal or event may also be used for generating the zone presence signal for the upstream equipment zone. Additionally, or alternatively, the zone presence signal is provided by mapping the real-time process data, which in a production environment is time-dependent data, to spatial data. The zone presence signal can hence be used for determining not only the process parameters and/or equipment operating conditions that are relevant for the processing of the input material 114 at the upstream equipment zone, but also the time aspect of said process parameters and/or equipment operating conditions which are included in the real-time process data.

The computing unit 124 may even compute at least one zone-specific performance parameter that is relevant for the chemical product 170, which is related to the upstream object identifier 122. The computation is based on the subset of real-time process data 126, which in this case is shown optionally appended at the upstream object identifier 122. The computation of the zone-specific performance parameter is also based on historical data which comprise data from one or more historical upstream object identifiers. Each historical upstream object identifier is related to the respective input material which was processed in the upstream equipment zone in the past. Each historical upstream object identifier is appended with at least a part of the process data which is indicative of the process parameters and/or equipment operating conditions that the previously processed input material was processed under in the upstream equipment zone.

The at least one zone-specific performance parameter may be appended to the upstream object identifier 122, for example as metadata. Thus, the upstream object identifier 122 is enriched with the performance parameter that is related to the quality of the chemical product 170. Quality control process can thus be simplified and improved while improving traceability, e.g., by coupling the quality related data with the resulting chemical product 170. Also, at least of the computed zone-specific performance parameters may be used downstream for adapting the production process downstream. The production process can thus become more granularly controlled and flexible whilst maintaining performance of the chemical product 170.

The subset of real-time process data 126 from the upstream equipment zone may be data within the time window that the input material 114 was at the upstream equipment zone, or the time window may be even shorter thus just for the time that the input material 114 was processed via the mixing pot 104. The real-time process data can be used to determine the time window. Hence, the upstream object identifier 122 can be enriched with high relevance data by using the time-dimension of the real-time process data. Thus, object identifiers not only can be used to track the material in the production process, but also encapsulate high quality data that can make edge computing and/or cloud computing more effective. The object identifier data can be highly suitable for faster training and retraining of machine learning models. Data integration can also be simplified as the data encapsulated in the object identifiers can be more compact than traditional datasets.

The at least part of subset of real-time process data 126 is indicative of the process parameters and/or equipment operating conditions, i.e., the operating conditions of the mixing pot 104 and valves 112a-b, that the input material is processed under in the upstream equipment zone, for example, any one or more of, incoming mass flow, outgoing mass flow, filling degree, temperature, moisture, time stamps or time of entry, time of exit, etc. The equipment operating conditions in this case may be control signals and/or set-points of the valves 112a,b and/or the mixing pot 104. The zone-specific control settings can for example be used to control these. The subset of real-time process data 126 may be or it may comprise time-series data, which means that it may include time dependent signals, which may be obtained via one or more sensors, for example, output of the fill sensor 144. The time-series data may comprise signals that are continuous or any of them may be intermittent with regular or irregular time intervals. The subset of real-time process data 126 may even include one or more time-stamps, for example time of entry and/or time of exit, from the mixing pot 104. Thus, a particular input material 114 may be associated with the subset of real-time process data 126 relevant for that input material 114 via the upstream object identifier 122. The upstream object identifier 122 may be appended to other object identifiers downstream of the production process such that specific process data and/or equipment operating conditions can be correlated to a specific chemical product. Other important benefits were already discussed in other parts of this disclosure, e.g., in the summary section.

The conveyor system comprising the transport elements 102a,b and the associated belt may be considered an intermediate equipment zone which is downstream of the upstream equipment zone. The intermediate equipment zone in this example comprises a heater 118 that is used for applying heat to the input material traversing on the belt. The conveyor system may even comprise one or more sensors, for example any one or more of, speed sensor, weight sensor, temperature sensor, or any other kind of sensor for measuring or detecting the process parameters and/or properties of the input material 114 at the intermediate equipment zone. Any or all outputs of the sensors may be provided to the computing unit 124.

As the input material 114 progresses along the direction of transverse 120, it is applied heat via the heater 118. The heater 118 may be operatively coupled to the computing unit 124, i.e., the computing unit 124 may receive signals or real-time process data from the heater 118. Furthermore, the heater 118 is controllable via the computing unit 124, for example via one or more control signals and/or set-points that may be the zone-specific control settings, or may be obtained via the zone-specific control settings. Thus, the way the input material 114 is processed at the upstream equipment zone is determined via at least some of the zone-specific control settings. Some of the zone-specific control settings may be used to control downstream zones as will be explained further.

Similarly, the conveyor system comprising the transport elements 102a,b and the associated belt may also be operatively coupled to the computing unit 124, i.e., the computing unit 124 may receive signals or process data from the transport elements 102a,b. The coupling may for example be via the network. Furthermore, the transport elements 102a,b may even be controllable via the computing unit 124, for example via one or more control signals and/or set-points provided via the computing unit 124, as or in response to the zone-specific control settings. So, the speed of the transport elements 102a,b may be observable and/or controllable by the computing unit 124.

Optionally, as the quantity of the input material 114 is constant or near constant in the intermediate equipment zone, a further object identifier may not be provided for the intermediate equipment zone. Thus, the process data from the intermediate equipment zone, i.e., from the heater 118 and/or the transport elements 102a,b may also be appended to the object identifier of the previous or preceding zone, i.e., the upstream object identifier 122. The appended subset of real-time process data 126 may thus be enriched to be further indicative of the process parameters and/or equipment operating conditions from the intermediate equipment zone, i.e., the operating conditions of the heater 118 and/or transport elements 102a,b, that the input material 114 is processed under in the intermediate equipment zone, for example, any one or more of, incoming mass flow, outgoing mass flow, one or more temperature values from the intermediate zone, time of entry, time of exit, speed of the transport elements 102a,b and/or belt, etc. The equipment operating conditions in this case may be control signals and/or set-points of the transport elements 102a,b and/or the heater 118, derivable from the zone-specific control settings.

It will be clear that the subset of real-time process data 126 predominantly relates to the time-periods within which the input material 114 is present in the respective equipment zone. Thus, an accurate snapshot of the relevant process data for the specific input material 114 can be provided via the upstream object identifier 122. Further observability of the input material 114 may be extracted via the knowledge of the specific portion or part of the production process, e.g., a chemical reaction, within the intermediate equipment zone. Alternatively, or in addition, the speed by with the input material 114 traverses through the intermediate equipment zone can be used to extract further observability via the computing unit 124. In conjunction with the subset of real-time process data 126 with specific time-stamps, or the time-series data, and/or time of entry and/or time of exit of the input material 114 in the intermediate equipment zone, a more granular detail of conditions under which the input material 114 is processed in the intermediate equipment zone may be obtained from the upstream object identifier 122.

The data from the upstream object identifier 122 may be used for training one or more ML models for monitoring and/or control of the production process as whole and/or the specific portions thereof, for example, the portion of the production process within the upstream equipment zone and/or the intermediate equipment zone. The ML model, preferably at least partially a data-driven model, and/or upstream object identifier 122 may even be used for correlating one or more performance parameters of the chemical product to the specifics of the production process in one or more zones.

It will be appreciated that as the input material 114 progresses along the direction of transverse 120, it may change its properties and may transform or convert to a derivative material 116. For example, as the heater 118 heats the input material 114, it may result in the derivative material 116. Those skilled in the art will appreciate that for simplicity and ease of understanding, the derivative material 116 may also be sometimes referred to as input material in the present teachings. For example, in context of the equipment zone or components under discussion, it will thus be clear in which phase the input material is within the production process as discussed in the description of this example.

Now discussing an example of a zone where a material is divided in multiple parts. FIG. 1 shows such a zone as a downstream equipment zone comprising a cutting mill 142 and second transport elements 106a,b. The derivative material 116 traversing along the direction of transverse 154 is divided or fragmented using the cutting mill 142, thus resulting in a plurality of parts, shown in this example as a first divided material 140a and a second divided material 140b.

Thus, according to an aspect of the present teachings, an individual object identifier may be provided for each part. In some cases though, an object identifier may only be provided for one of the parts, or for some of the parts, instead of providing an individual object identifier for each part. This may be the case, for example if tracking any of the parts is not of interest. For example, an object identifier may not be provided for a part of the derivative material 116 that is discarded. Now referring back to FIG. 1, a first downstream object identifier 130a is provided for the first divided material 140a and a second downstream object identifier 130b is provided for the second divided material 140b.

The first downstream object identifier 130a comprises at least a part of the upstream object identifier 122 and similarly the second downstream object identifier 130b comprises at least a part of the upstream object identifier 122. The computing unit 124 may then determine an another subset of the real-time process data (e.g., a first subset of downstream real-time process data 132a and or second subset of downstream real-time process data 132b) based on the downstream object identifier and the zone presence signal. The computing unit 124 may then determine further zone-specific control settings for the downstream equipment zone and optionally also for other equipment zones downstream of the downstream equipment zone, based on data from the upstream object identifier 122, the another subset of the real-time process data and historical data from one or more historical downstream object identifiers related to previously processed input material in the downstream equipment zone.

The first downstream object identifier 130a is optionally appended with the first subset of downstream real-time process data 132a and the second downstream object identifier 130b is optionally appended with the second subset of downstream real-time process data 132b. The first subset of downstream real-time process data 132a may be a copy of the second subset of downstream real-time process data 132b, or they may partly be the same data. For example, in cases when the first divided material 140a and the second divided material 140b undergo the same process, i.e., at essentially the same place and time, then the process data appended to the downstream object identifier 130a and the second downstream object identifier 130b may be the same or similar. If, however, within the downstream equipment zone the downstream object identifier 130a and the second downstream object identifier 130b were to be treated differently, the first subset of downstream real-time process data 132a and the second subset of downstream real-time process data 132b may be different from each other.

Those skilled in the art will appreciate that in some cases, however, optionally only one object identifier may be provided at the cutting mill 142 and then multiple object identifiers may be provided subsequent to the cutting mill 142 if the material processed via the cutting mill 142 is split in multiple parts. Thus, dependent upon the specifics of a particular production process, a cutting mill may or may not be a separation device. Similarly, in some cases no new object identifier may be provided for a cutting mill such that process data from the zone is appended to the preceding object identifier. New object identifier may thus be provided at the zones where the material is split and/or it is combined. For example, in some cases, the downstream object identifier 130a and the second downstream object identifier 130b may be provided after the cutting mill 142, for example at entry at the different zones subsequent to the cutting mill 142.

In this example, the downstream equipment zone also comprises an imaging sensor 146, which may be a camera or any other kind of optical sensor. The imaging sensor 146 may also be operatively coupled to the computing unit 124. The imaging sensor 146 may be used for measuring or detecting one or more properties of the derivative material 116 prior to entering the downstream equipment zone. This may for example be done to reject or divert the material that does not meet a given quality criteria. As mass flow of the material is altered in the downstream equipment zone, according to an aspect of the present teachings, another object identifier (not shown in FIG. 1) may have been provided prior to the downstream object identifier 130a and the second downstream object identifier 130b.

The providing of the downstream object identifier 130a and the second downstream object identifier 130b may be triggered in response to the derivative material 116 passing the quality criteria via the imaging sensor 146. By correlating data from the adjacent zones or from the object identifiers, for example, mass flow from the intermediate equipment zone and mass flow to the downstream equipment zone, the computing unit 124 may determine which specific input material 114 or derivative material 116 is related to the material entering the subsequent zone. Alternatively, or in addition, two or more of the time stamps may be correlated between the zones, for example time-stamp of exit from the intermediate equipment zone and time-stamp of detection via the imaging sensor 146 and/or entry at the downstream equipment zone. The speed of the transport elements 102a,b either measured directly via a sensor output or determined from two or more time-stamps can also be used to establish relationship between a specific packet or batch of input material and its object identifiers. It may thus even be determined where the specific chemical product 170 was within the production process at a given time, thus a time-space relationship may be established. Some or all of these aspects can be usable not only in improving the traceability of the chemical product 170 from input material to finished product, but also in monitoring and improving the production process and making it more adaptable and controllable.

As discussed, the first downstream object identifier 130a and the second downstream object identifier 130b are appended with the first subset of downstream real-time process data 132a and the second subset of downstream real-time process data 132b respectively from the downstream equipment zone. The first subset of downstream real-time process data 132a and the second subset of downstream real-time process data 132b may even be linked to or appended with the upstream object identifier 122. Similar to the previously discussed upstream object identifier 122, the first subset of downstream real-time process data 132a and the second subset of downstream real-time process data 132b are indicative of the process parameters and/or equipment operating conditions, i.e., the output of the imaging sensor 146, the operating conditions of the cutting mill 142 and the second transport elements 106a,b, that the derivative material 116 is processed under in the downstream equipment zone, for example, any one or more of, incoming mass flow, outgoing mass flow, filling degree, temperature, optical properties, time stamps, etc. The equipment operating conditions in this case may be control signals and/or set-points of the cutting mill 142 and/or the second transport elements 106a,b, that may be derived from the further zone-specific control settings. The further zone-specific control settings can thus be optimized based upon the data from the upstream object identifier 122, for example the at least one zone-specific performance parameter appended to the upstream object identifier 122.

The first subset of downstream real-time process data 132a and the second subset of downstream real-time process data 132b may comprise time-series data, which means that it may include time dependent signals, which may be obtained via one or more sensors, for example, output of the imaging sensor 146 and/or speed of the second transport elements 106a,b.

As the derivative material 116 proceeds after encountering the imaging sensor 146, it is moved towards the cutting mill 142 in the direction of transverse 154 driven by the second transport elements 106a,b. The second transport elements 106a,b are in this example shown as a part of a second conveyor belt system separate from the conveyor system comprising transport elements 102a,b. It will be appreciated that it the second conveyor belt system may even be a part of the same conveyor system comprising transport elements 102a,b. Accordingly, the downstream equipment zone may comprise some of the same equipment used in another zone.

As can be seen in FIG. 1, even though the first divided material 140a and the second divided material 140b go different ways later in production, their respective object identifier i.e., downstream object identifier 130a and the second downstream object identifier 130b allow following or tracking them individually through the remaining production process and in some cases also beyond.

After exiting the downstream equipment zone, the first divided material 140a is fed to an extruder 150, while the second divided material 140b is transported for curing at a third equipment zone comprising a curing apparatus 162 and third transport elements 108a,b. The transport elements 108a,b shown are accordingly a non-limiting example, as discussed previously. It will be appreciated that the third equipment zone is downstream of the upstream equipment zone and the downstream equipment zone.

As the second divided material 140b is moved via a belt in the direction of transverse 156, it undergoes the curing process via the curing apparatus 162 to result on a cured second divided material 160. Since no substantial mass change may occur, according to an aspect, no new object identifier may be provided for the third equipment zone. Accordingly, as previously discussed, the process data from the third equipment zone may also be appended to the second downstream object identifier 130b. Similar to the above, the appended second subset of downstream real-time process data 132b may thus be enriched to be further indicative of the process parameters and/or equipment operating conditions from the third equipment zone, i.e., the operating conditions of the curing apparatus 162 and/or transport elements 108a,b, that the second divided material 140b is processed under in the third equipment zone, for example, any one or more of, incoming mass flow, outgoing mass flow, one or more temperature values from the third zone, time of entry, time of exit, speed of the transport elements 108a,b and/or belt, etc. The equipment operating conditions in this case may be control signals and/or set-points of the transport elements 102a,b and/or the curing apparatus 162 that may also be derived from the further zone-specific control settings. The further zone-specific control settings can thus be optimized based upon the data from the upstream object identifier 122, for example the at least one zone-specific performance parameter appended to the upstream object identifier 122.

Similarly, the first divided material 140a progresses to a fourth equipment zone comprising the extruder 150, a temperature sensor 148 and fourth transport elements 110a,b. Here too, as no substantial mass change may occur, according to an aspect, no new object identifier may be provided for the fourth equipment zone. Accordingly, as previously discussed, the process data from the fourth equipment zone may also be appended to the downstream object identifier 130a. Similar to the above, the appended first subset of downstream real-time process data 132a may thus be enriched to be further indicative of the process parameters and/or equipment operating conditions from the fourth equipment zone, i.e., the operating conditions of the extruder 150 and/or the temperature sensor 148 and/or transport elements 108a,b, that the first divided material 140a is processed under in the third equipment zone, for example, any one or more of, incoming mass flow, outgoing mass flow, one or more temperature values from the third zone, time of entry, time of exit, speed of the transport elements 110a,b and/or belt, etc. The equipment operating conditions in this case may be control signals and/or set-points of the transport elements 108a,b and/or the extruder 150, which can also be adapted as explained earlier based on computed performance parameters and relevant real-time process data.

Also, properties and dependencies of transformation of the first divided material 140a to an extruded material 152 may also be included in the downstream object identifier 130a. It will be appreciated that the fourth equipment zone is also downstream of the upstream equipment zone and the downstream equipment zone.

As can be appreciated, the number of individual object identifiers can be reduced while improving material and product monitoring throughout the production process.

As the extruded material 152 moves further in the direction of traverse 158 generated via the transport elements 108a,b, it may be collected in a collection zone 166. The collection zone 166 may be a storage unit, or it may be a further processing unit for applying further steps of the production process. In the collection zone 166, additional materials may be combined, as shown here that the cured second divided material 160 may be combined with the extruded material 152. Accordingly, a new object identifier may be provided as previously discussed. Such an object identifier is shown as a last downstream object identifier 134. The last downstream object identifier 134 may be appended with a subset of last zone real-time process data 136, which may include whole or a part of the downstream object identifier 130a and the second downstream object identifier 130b. The last downstream object identifier 134 is thus provided with the process parameters and/or equipment operating conditions from the collection zone 166, similar to as was discussed in detail in this disclosure. Depending upon the function or further processing if any done in the collection zone 166, data such as, any one or more of, incoming mass flow, outgoing mass flow, one or more temperature values from the collection zone 166, time of entry, time of exit, speed, etc. may be included as last zone real-time process data 136.

In some cases, individual lots from the collection zone 166 may be sent for storage and/or sorting and/or packaging. Such an individual lot is shown as product collection bin 164a. As quantities are being split again, an individual object identifier may be provided for each of the silos such that the chemical product 170 in its silo, i.e., the individual object identifier for the product collection bin 164a can be associated with the process data or conditions that the chemical product 170 is exposed to there.

As will be appreciated, each of the object identifiers may be a GUID. Each may include wholly or partly data from the preceding object identifier, or they may be linked. The relevant quality data can thus be attached as a snapshot or traceable link to a particular chemical product 170.

As was also discussed, one or more ML models, preferably at least partially data-driven models, may be used for computing or predicting one or more zone specific performance parameters and/or the zone-specific control settings. It is also possible that each or some of the ML models also are configured to provide a confidence value indicative of the confidence level for the at least one zone-specific performance parameter and/or the zone-specific control settings. A warning may be generated as a warning signal, for example to initiate a physical test of a sample for lab analysis should the confidence level in predicting the performance parameter be low than a predetermined limit. It is also possible that in response to the confidence level of the prediction falling below an accuracy threshold value, a sampling object identifier is automatically provided via the interface. The sampling object identifier may be provided in a similar way and the computing unit 124 may append the subset of relevant process data to the sampling object identifier for the material which the sampling object identifier relates to, shown here as a sample material 172. The computing unit 124 may also append the at least one zone-specific performance parameter, which had low confidence level, to the sampling object identifier. The sample material 172 can thus be collected and verified and/or analyzed to further improve the quality control using object identifiers.

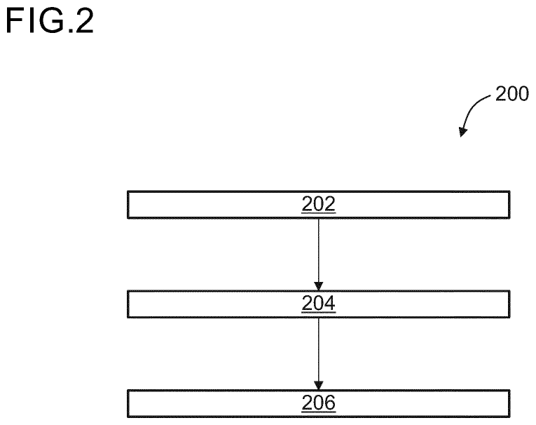

FIG. 2 illustrates a flow chart 200 or routine showing method aspects of the present teachings, especially as viewed from the first equipment zone. In block 202, it is provided, via an interface, an upstream object identifier 122 comprising input material data and at least one desired performance parameter related to the chemical product 170. The input material data is indicative of one or more property of the input material 114. In block 204, it is determined, via the computing unit 124, a set of process and/or operation parameters based on the upstream object identifier 122 and the at least one desired performance parameter. The desired performance parameter is indicative of a desired performance or quality of the chemical product 170. In block 206, it is determined, zone-specific control settings for each of the equipment zones based on the determined set of process and/or operation parameters and historical data. The historical data may comprise data from one or more historical upstream object identifiers related to previously processed input material, for example, in the upstream equipment zone. According to an aspect, at least one, but most preferably each historical upstream object identifier has been appended with at least a part of the process data which is indicative of the process parameters and/or equipment operating conditions that the previously processed input material was processed under in the upstream equipment zone. In block 208, it is provided, via an output interface, the zone-specific control settings for controlling the production of the chemical product 170 related to the upstream object identifier 122. In optional block 210, it is executed to the production process using the zone-specific control settings.

Similarly, as the input material progresses to a subsequent zone, it may be determined if another object identifier is to be provided or not. If not, then the process data from the subsequent zone may also be appended to the same object identifier. If it is determined that another object identifier is to be provided, then the process data from the subsequent zone is appended to the other object identifier. Details for each of these options, such as the intermediate equipment zone and the downstream equipment zone are discussed in detail in the present disclosure, for example, in the summary section as well as with reference to FIG. 1.

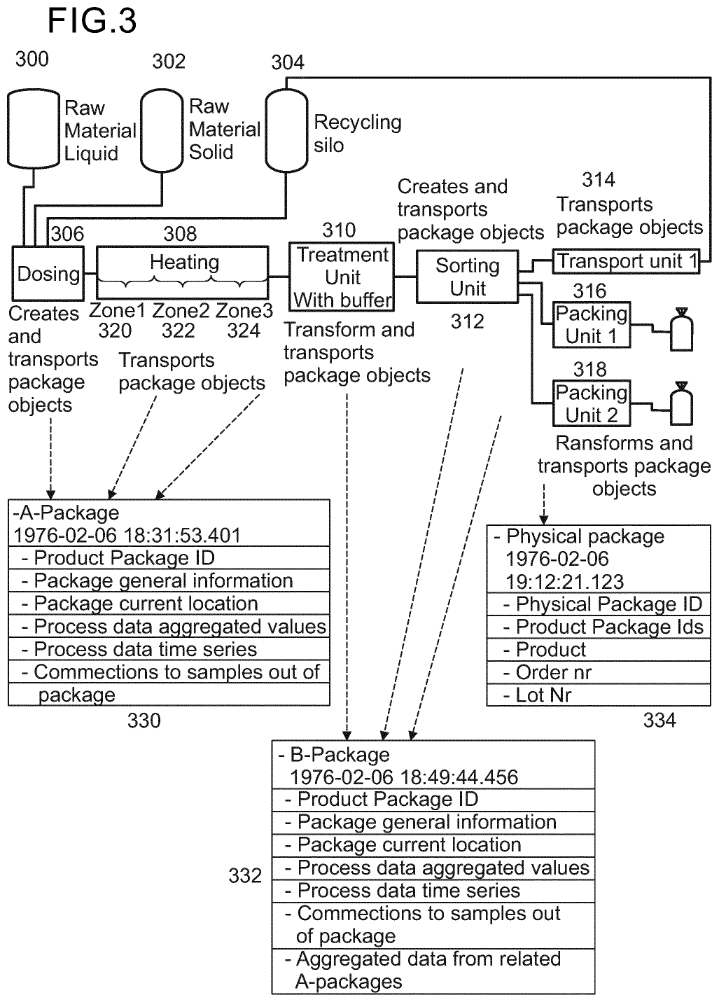

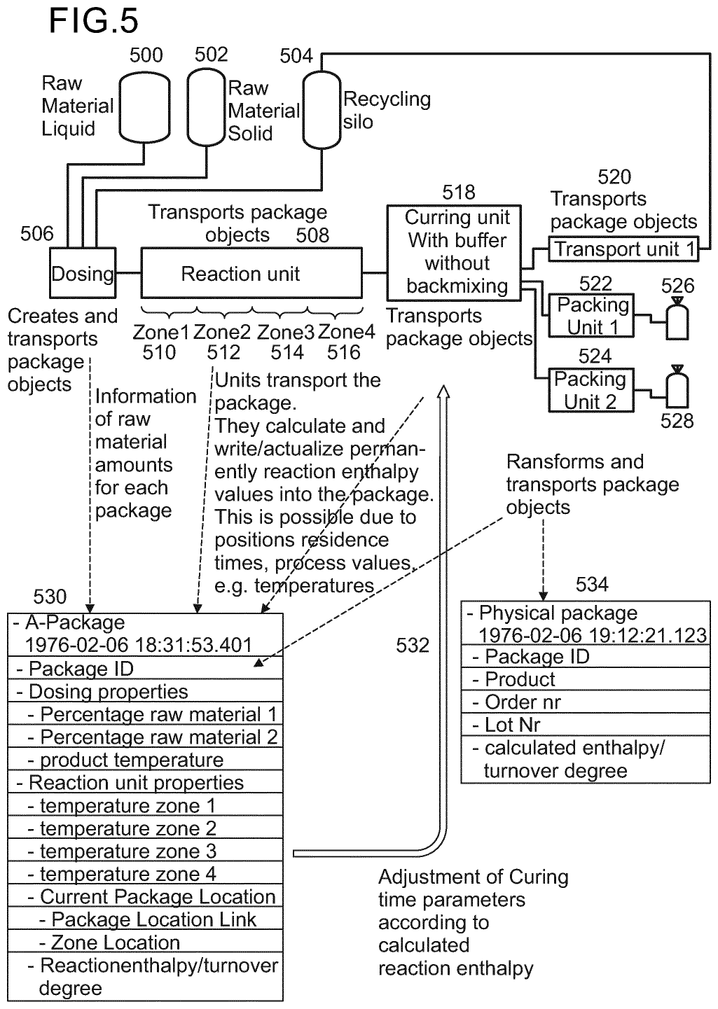

The block diagram shown in FIG. 3 represents parts of a product production system of an industrial plant, which, in the present embodiment, comprises ten product processing devices or units 300-318, or technical equipment respectively, being arranged along the shown entire product processing line. In the present embodiment one of these processing units (processing unit 308) includes three corresponding equipment zones 320, 322, 324 (see also more detailed embodiments in FIGS. 3 and 5).

In the present example a chemical product, as input material, is produced based on a raw material which is provided to the processing line via a liquid raw material reservoir 300, a solid raw material reservoir 302, and a recycling silo 304 which recycles any chemical products or intermediate products that e.g. comprise insufficient material/product properties or an insufficient material/product quality, The respective raw material being input to the processing line 306-318 is processed via the respective processing equipment, namely a dosing unit 306, a subsequent heating unit 308, a subsequent treatment unit including a material buffer 310, and a subsequent sorting unit 312. Downstream of this processing equipment 306-312, there is arranged a transport unit 314 which transports material that needs to be recycled, e.g. due to insufficient quality of the produced material, from the sorting unit to the recycling silo 304. Finally, the material being sorted by the sorting unit 312 is transferred to a first and a second packing unit 316, 318 which pack the according materials into material containers for shipping purposes, e.g. material bags in case of bulk material or bottles in case of liquid material.

The production system 300-318, in the present embodiment, provides a data interface of a computing unit (both not being depicted in this block diagram), via which data objects comprising data about the respective input materials and their changes due to the processing are provided. The entire production process is, at least partially, controlled via the computing unit.

The input material(s) being processed by the processing equipment 306-312 is(are) divided into physical or real-world so-called “package objects” (in the following also called “physical packages” or “product packages”), wherein these package objects are handled or processed by each of the processing units 306-312. The package size of such package objects can be fixed, e.g. by material weight (e.g. 10 kg, 50 kg, etc.) or by material amount (e.g. 1 decimeter, 1/10 cubic meter, etc.), or even can be determined by a weight or amount, for which considerably constant process parameters or equipment operation parameters can be provided by the processing equipment.

The dosing unit 306 first creates such package objects from the input liquid and/or solid raw material and/or the recycled material provided by the recycling silo 304. Having created the package objects, the dosing unit transports these objects to the homogenization unit 308. The homogenization unit 308 homogenizes the materials of the package objects, i.e. homogenizes e.g. a processed liquid material and a solid material, or two liquid or solid materials. After the heating process, the heating unit 308 transports the accordingly heated package objects to the treatment unit 310 which transforms the material of the input package objects into a different physical and/or chemical state, e.g. by heating, drying or humidifying or by a certain chemical reaction. The accordingly transformed package objects are then transported to one or more of the three downstream packing units 316, 318 or the mentioned transport unit 314.

The subsequent processing of the real-world package objects is managed by means of corresponding data objects 330, 332, 334 (or pre-described “object identifiers”, respectively) which are assigned to each package object via the computing unit operatively coupled to the equipment 306-312, or being a part of the equipment, and is stored at a memory storage element of the computing unit. According to the present embodiment, the three data object 330-334 are generated in response to a trigger signal which is provided via the equipment 306-312, namely in response to the output of a corresponding sensor being arranged at each of the equipment units 306-312, or according switches respectively, wherein such sensors are operatively coupled to the equipment units 306-312. As mentioned beforehand, the industrial plant may include different types of sensors, e.g. sensors for measuring one or more process parameters and/or for measuring equipment operating conditions or parameters related to the equipment or the process units. In the present embodiment, sensors for measuring the flowrate and the level of the bulk and/or liquid materials processed inside the equipment units 306-312 are arranged at these units.

The three exemplary data objects 330, 332, 334 depicted in FIG. 3, in the present embodiment, each relate to different the three equipment zones 320, 322, 324 of the entire product production process based on the processing units 306-312 and 314-318.

The first two data objects 330, 332 comprise product package objects which contain process data. The process data comprises processing/treatment information which the related physical package has experienced during its residence/treatment within the several processing units. The process data can be aggregated data such as a calculated average temperature during the residence time of the underlying physical package within the related processing units and/or it can be time series data of the underlying production processes.

The first data object 330 is a first kind of package (in FIG. 3 called “A-Package”) which, in the present embodiment, is assigned to a physical package that has been transported through the two processing units, the Dosing unit 306 and the Heating unit 308. The first data object 330 includes, at the present point in processing time, the related data of both units during each residence. The first data object includes a corresponding “Product Package ID”.

The Heating unit 308 contains several equipment zones, in the present embodiment, three equipment zones 320, 322, 324 (“Zone 1”, “Zone 2”, “Zone 3”). These different equipment zones are utilized as sorting group for sorting or selecting the related process data. Such a sorting may help to obtain only those data for a package object out of a related equipment zone, which relate to the processing of the underlying physical package within the corresponding point in time during which the related physical package is inside this equipment zone. However, in the present embodiment, the material composition of the physical package is not changed by both processing units 306, 308.

Once the A-package 330 has arrived at the next Treatment unit 310 (in the present embodiment a “treatment unit with buffer”), the material composition of each physical package changes, because this processing unit 310 not only transports physical packages in a plug flow mode. Moreover, corresponding physical packages comprise a buffer volume which is bigger than the original package size, so that such physical packages have a defined back-mixing degree. As a consequence, each physical package which leaves this Treatment unit 310, is another kind of physical package, which is called “B-package” in FIG. 3.

The corresponding second data object 332 (“B-package”) also includes a corresponding “Product Package ID”. The data object 332 further includes the data of a defined number of previous data objects, in the present example the data object 330 designated as “A-Package”, in a defined percentage, the so-called “Aggregated data from related A-packages”. An according aggregation scheme or algorithm depends e.g. on the underlying processing unit, on the size of the underlying physical package, on the mixing capabilities of the material of the underlying physical package and on the residence time of the underlying physical package within the underlying processing unit, or a corresponding equipment zone of the processing unit.

Once processed physical (product) packages are packed by one of the two Packing units 316, 318 into discrete physical packages, e.g. by packing processed physical packages into a container, a drum or into an octabin vessel or the like, in the present embodiment, corresponding packed physical packages are handled or tracked via another data object 334 called “Physical package”. This data object 334 includes related previous physical packages (like the “A-Package” and the “B-Package” in the present scenario) which have been packed into it. The designation of corresponding “Product Package IDs” is sufficient e.g. for tracking purposes, instead of using complete data objects, because such Product Package IDs can be easily linked together during a later data processing, e.g. data processing performed by means of an external “cloud computing” platform.

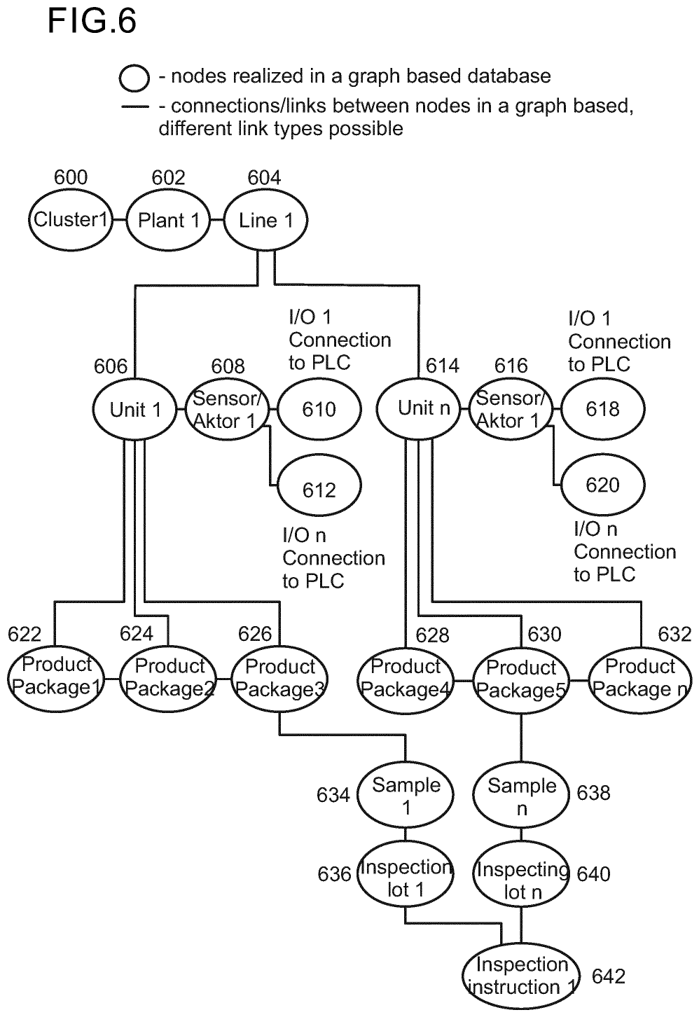

The first data object (or “object identifier”) 330 particularly includes the following information:
A “Product Package ID” for an underlying package;
general information about the underlying package, like information, or a specification, about the underlying processed material(s) of the package;
the current location of the underlying package within the entire processing line 306-318;
process data, i.e. as aggregated values of temperature and/or weight of the processed material(s) of the underlying package;
time series data of the underlying production process; and
connections to samples out of the underlying package, wherein a product package passes a sample station and, at a defined moment, an operator takes a sample out of this product package and provides it to a lab. For this sample, a sample object (see FIG. 6, reference signs 634 and 638) will be generated and will be linked to the related product package (see FIG. 6, reference signs 626 and 630). This sample object, in particular, contains corresponding product quality control (QC) data from the lab and/or performance data from according testing machines.

The second object identifier 332 additionally includes
aggregated data from related A-packages which is generated in the treatment unit with buffer 310.

The third object identifier 334 is generated by the two packing units 316, 318 with the designation and time stamp “Physical package 1976-02-06 19:12:21.123” and includes the following information:
Again, an according package or object identifier (“Package ID”);
the name of the product being packed into the two material containers for shipping purposes depicted in FIG. 3;
the order number for ordering the product being packed accordingly; and
the Lot number of the product being packed accordingly.

The package general information of the first and second object identifier 330, 332 includes material data of the input raw material, which in the present embodiment, is indicative of a chemical and/or physical property of the input material, or processed material(s) respectively, like the material(s) temperature and/or weight, and in the present embodiment comprises also above mentioned lab sample or test data related to the input material, such as historical test results.

According to the product production process also illustrated by FIG. 3, via the mentioned interface, process data from the overall equipment are gathered which are indicative of process parameters like the mentioned temperature and/or weight of the processed material(s), and in the present embodiment also of equipment operating conditions that the input material is processed under, like the temperature of a mentioned heater and/or the applied dosing parameters. The gathered process data, in the present embodiment only part of the process data like the aggregated data from related A-packages, in the present embodiment, are appended to the second object identifier 332.

As described beforehand, the three object identifiers 330-334, in the present embodiment, are used for correlating or mapping the mentioned input material data and/or specific process parameters and/or equipment operating conditions to at least one performance parameter of the chemical product, said performance parameter being, or it being indicative of, any one or more properties of the underlying material(s), e.g. an according chemical product, respectively.

According to the present embodiment shown in FIG. 3, the gathered process data (as aggregated values) included in the two object identifiers 330, 332 comprise numerical values indicative of the process parameters, and additionally of the equipment operating conditions measured during the production process. In addition, the object identifiers 330, 332 include process data being provided as time-series data of one or more of the process parameters and/or the equipment operating conditions. The equipment operating conditions can be any characteristics or values that represent the state of the equipment, in the present embodiment, production machine setpoints, controller outputs, and any equipment related warning, e.g. based on vibration measurements. Additionally, the transport element speed, temperature and fouling value such as filter differential pressure, a maintenance date can be included.

In the embodiment of the product production system shown in FIG. 3, the entire product processing equipment 306-318 comprises the mentioned plurality of three equipment zones 320-324 such that during the production process, the input raw material(s) 300-304 traverses along the entire processing line 306-318 and, in the present embodiment, progresses from the first equipment zone 320 to the second equipment zone 322 and from the second equipment zone 322 to the third equipment zone 324. In such a production scenario, the first object identifier 330 is provided at the first equipment zone 320, wherein the second object identifier 332 is provided at the entry of the input material at the second equipment zone 322, after having been processed through the first equipment zone 320. The second object identifier 332 is appended with or includes at least part of the data or information provided by the first object identifier 330 and additionally includes the last data/information “Aggregated data from related A-packages”.

It is noteworthy that any or each of the object identifiers 330-334 may include a unique identifier, preferably a globally unique identifier (“GUID”), in order to allow for a reliable and safe assignment of an object identifier to a corresponding package during the whole production process.

In the present product processing scenario, the mentioned process data appended to the first object identifier 330 are at least part of the process data gathered from the first equipment zone 320. Accordingly, the second object identifier 332 is appended with at least part of the process data gathered from the second equipment zone 322, wherein the process data gathered from the second equipment zone 322 are indicative of the process parameters and/or equipment operating conditions that the input raw material(s) 300-304 is processed under in the second equipment zone 322.

In the following TABLE 1, another exemplary object identifier is shown, again in a tabular format. This object identifier includes much more information/data than the previously described three object identifiers 330-334.

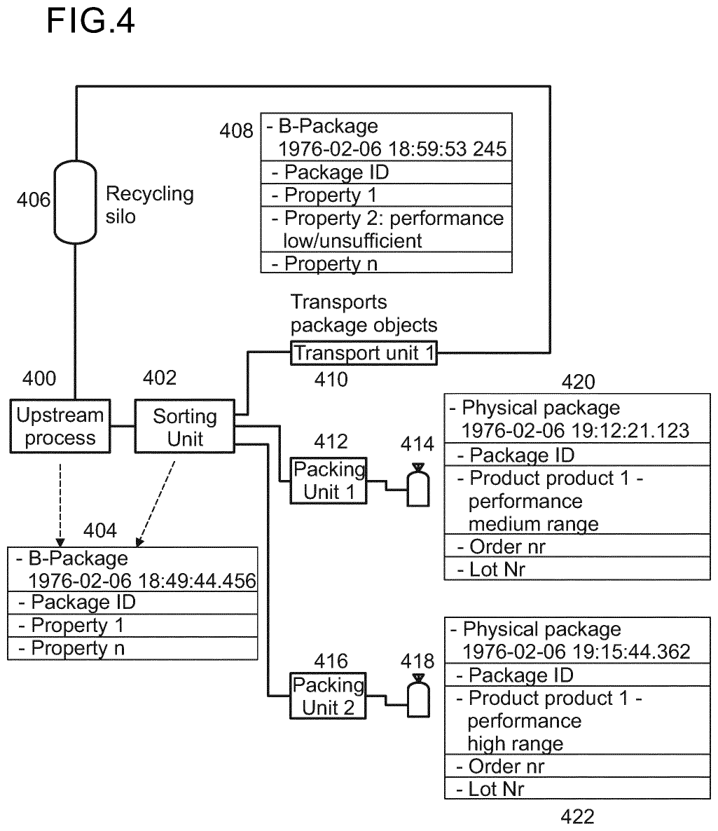

This exemplary object identifier concerns a so-called “B-Package” with an underlying date and time stamp “1976-02-06 18:31:53.401”, like that shown in FIG. 4 being described in the following but including more data than that included in FIG. 4.

The unique identifier (“Unique ID”), in the present example, comprises a unique URL (“uniqueObjectURL”). The main details of the underlying package (“Package Details”), in the present example, are the date and timestamp of the creation of the package (“Creation Timestamp”) having the two values “02.02.1976 18:31:53.401” and the type of the package (“Package Type”), in the present example having a package type “B”. The current location of the package along the underlying production line (“Package Location”) is defined by a “Package Location Link”, in the present example a transport link to a “Conveyor Belt 1” of the production line.

At the Conveyor Belt 1, there is provided measuring equipment (see “Measuring Points” which include exemplary processing data or values) for measuring the average temperature (“Average Value”) currently revealing a material temperature of 85° C. and an according description (“Description”) of the underlying temperature zone, in the present example “Temperature Zone 1”. In addition, the measuring equipment can also include sensors for detecting the entry date/time of the package at the Conveyor Belt 1 (“Entry Time”), in the present example being “02.02.1976 18:31:54.431” and for detecting the leaving date/time of the package from the Conveyor Belt 1 (“Leaving Time”), in the present example being “02.02.1976 18:31:57.234”. Finally, the measuring equipment includes sensor equipment for detecting time series values (“Time Series Values”) of underlying time series information (“Time Series”) concerning the production process.

In addition, the shown object identifier, in the present example, further includes information about a downstream located “Conveyor Belt 2”, a downstream located “Mixer 1” and a downstream located “Silo 1” for intermediately storing already processed material(s).

TABLE 1
Exemplary tabular object identifier

| | |
|---|---|
| B-Package 1976 Feb. 6 18:31:53.401 | |
| Unique ID: | |
| Unique URL | uniqueObjectUrl |
| Package Details | |
| Creation Timestamp | Feb. 2, 1976 18:31:53.401 |
| Package Type | B |
| Package Location | |
| Package Location Link: | Conveyor Belt 1 |
| Conveyor Belt 1 | |
| Measuring Point | |
| Average Value | 85° C. |
| Description | Temperature Zone 1 |
| Entry Time | Feb. 2, 1976 18:31:54.431 |
| Leaving Time | Feb. 2, 1976 18:31:57.234 |
| Time Series | Time Series Values |
| Conveyor Belt 2 | |
| Mixer 1 | |
| Silo 1 | |

FIG. 4 shows a second embodiment of ‘process parts of an underlying product production system of an industrial plant, which, in the present second embodiment, comprises six product processing devices 400, 402, 406, 410, 412, 416, or technical equipment, respectively.

An “Upstream process” 400 for processing package objects is connected to a “Sorting Unit” 402 for sorting the processed package objects. The upstream process 400 and the sorting unit 402 are managed by means of a first data object 404. This data object 404 concerns an already described “B-Package” with an underlying date and time stamp “1976-02-06 18:51:43.431” depicting the date and time of its creation. The data object 404 includes a “Package ID” of a currently processed package object (so-called “object identifier”). The data object 404 further includes n pre-described chemical and/or physical properties about the currently processed package object, in the present example a “Property 1” and a “Property n”.

The input materials, i.e. the corresponding package objects being fed in to the upstream process 400, in the present example, are provided by a “Recycling Silo” 406. The recycling silo 406, on the other hand, gets the underlying recycled materials from a “Transport unit 1” 410 which transports package objects, that have to be recycled and are sorted out by the sorting unit 402 accordingly, to the recycling silo 406. The underlying transport process step 410 is managed by means of a second data object 408 which concerns the above described “B-Package” and includes the mentioned underlying date and time stamp “1976-02-06 18:51:43.431”, the “Package ID” of the currently processed package object and the two chemical and/or physical properties “Property 1” and a “Property n”. However, due to the mentioned requirement to recycle the underlying sorted-out package object, the second data object 408 further includes another chemical and/or physical property of the underlying package object, in the present example a “Property 2”, which particularly includes a respective performance indicator for that package object, in the present example a “low or insufficient material or product performance”.

Package objects being processed by the upstream process 400 and not being sorted out by the sorting unit 402 are provided by the sorting unit 402 to either a first “Packing Unit 1” 412 or a second “Packing Unit 2” 416, depending on performance values for the corresponding package objects. The packing units 412, 416 are used for packing the corresponding package objects to respective containers 414, 418. The packing process being executed by the two packing units 412, 416 is managed by means of a third data object 420 and a fourth data object 422.

The two data objects 420, 422 both concern “Physical Packages” and include the same date “1976-02-06” as the above described “B-Package”, but a later time stamp “19:12:21.123” than the above described “B-Package”. They also include the “Package ID” of the underlying package objects. However, the data objects 420, 422 further include performance indicators for the underlying final products, in the present example a “performance medium range” regarding the products stored in the first container (or filling sack) 414 and a “performance high range” in case of the products stored in the second container (or filling sack) 418. In addition, the two data objects 420, 422 include the “Order no.” and “Lot no.” of the corresponding final products.

FIG. 5 shows a third embodiment of parts of an underlying chemical product production process or system implemented at an industrial plant, which, in the present second embodiment, comprises nine product processing devices 500-516, or technical equipment respectively.

The present product processing approach is based on two raw materials, namely a “Raw Material Liquid” 500 and a “Raw Material Solid” 502, in order to produce a polymeric material in a known manner. Like in the previously described production scenarios according to FIGS. 3 and 4, the technical equipment includes a “Recycling silo” 504 for using recycled materials, as described beforehand.

The technical equipment further includes a “Dosing unit 506” for creating package objects based on the mentioned input raw materials which are processed by a “Reaction unit” 508 which transports package objects along the shown four polymeric reaction zones (“Zones 1-4”) 510, 512, 514, 516 in order to process them and by a “Curing unit” 518 for curing the polymeric material (i.e. the corresponding package objects) being produced in the reaction unit 508. The curing unit 518, in the present embodiment, comprises only a material buffer, but not a back-mixing equipment. The curing unit 518 also transports accordingly processed package objects.

A “Transport unit 1” 520 transports package objects being sorted out for their recycling by means of the recycling silo 504. The finally processed, i.e. not sorted out, units are transported again to a first “Packing Unit 1” 522 and to a second “Packing Unit 2” 524. The two packing units 522, 524 transform and transport the corresponding package objects to respective containers or filling sacks 526, 528.

The production process depicted in FIG. 5 is managed by means of a first data object 530 and a second data object 534.

The first data object 530 concerns an “A-Package” with creation date “1976-02-06” and creation time “18:31:53.401”. The data object 530, in the present production scenario, includes again a pre-described “Package ID”, process information about the dosing process (“Dosing properties”) being performed by the dosing unit 506, and further process information (“Reaction unit properties”) about the production of the polymeric material by means of the reaction unit 508. The dosing properties include information about the raw material amounts for each package object, namely the “Percentage raw material 1 (liquid)”, the “Percentage raw material 2 (solid)” and the product temperature. The Reaction unit properties include the temperatures of the four polymeric reaction zones 510-516 (“temperature zone 1”, “temperature zone 2”, “temperature zone 3” and “temperature zone 4”).

Thereupon, the first data object 530 includes the current location of an underlying package object (“Current Package Location”) along the processing line 506-524. The current location of that package object, in the present embodiment, is managed by means of a “Package Location Link” and a corresponding “Zone location”. Finally included is chemical and/or physical information about the underlying polymeric reaction, namely the corresponding “Reaction enthalpy/turnover degree”. Hereby, the processing units 506-524 which transport a given package object, calculate and write/actualize permanently reaction enthalpy values into the first data object 530. This is possible due to existing information about package positions and corresponding residence times and about according process values, e.g. package temperatures. Based on the current values of the reaction enthalpy and/or turnover degree included in the first data object 530, via a communication line 532 between the first data object 530 and the curing unit 518, the curing time parameters are adjusted, based on a calculated value of the reaction enthalpy.

The second data object 534 concerns a “Physical package” being processed by one of the packing units 522, 524 and includes the corresponding creation date/time information “1976-02-06 19:12:21.123”. Included are a “Package ID”, a “Product” description/specification, an “Order no.”, a “Lot no.” and the mentioned value of the calculated enthalpy and/or turnover degree.

FIG. 6 shows a first embodiment of a graph-based database arrangement representing the hierarchical or topological structure of an underlying industrial plant 602, which is part of a cluster 600 of industrial plants, and which includes a plurality of equipment devices and corresponding equipment zones being part of an according product processing line 604. This topological structure allows to visualize the functional relationship between the underlying different parts of the industrial plant 602 (or underlying plant cluster 600) in order to enable an improved processing or planning of underlying product packages. The shown circular nodes of the graph-based database are linked via connection lines, for which different link types are possible.

The equipment devices, in this embodiment, include material processing units 606, 614 which are connected via a signal and/or data connection with sensors/actors 608, 616 being part of the processing units 606, 614 and which are connected to several input/output (I/O) devices 610, 612 and 618, 620.

In the present embodiment, the first processing unit 606 is further connected with exemplary three product packages (Product Packages 1-3) 622, 624, 626, wherein the second processing unit 614 is further connected with further three product packages (Product Packages 4-n) 628, 630, 632. Only exemplary, “Product Package 3” 626 is connected to a product sample (Sample 1) 634, wherein “Product Package 5” 630 is connected to another product sample (Sample n) 638. “Sample 1” 634 is further connected with an “Inspection lot 1” 636, wherein “Sample n” is further connected with an “Inspection lot n” 640. Finally, both inspection lots 636, 640 are connected with an “Inspecting Instruction 1” unit 642 which serves as a specification on how to create a mentioned inspection lot and on how to realize the analysis/quality control of a respective underlying sample 634, 638.

The topological structure shown in FIG. 6, advantageously provides data structures which allow for an intuitive and easy understanding of the functionality and processing of a shown chemical plant and thus an easy manageability of such a complex production process in the chemical plant or cluster of chemical plants by a user, in particular a machine/plant operator, since the shown objects (nodes) are modelled very similar like the corresponding real-world objects.

More particularly, this topological structure provides a high degree of contextual information, based on which the user/operator can easily gather the technical and/or material property of each object. This additionally allows for rather complex queries by the user, e.g. about relevant production-related connections or relations between objects, particularly across several nodes or even topology/hierarchy levels. Thereupon, the objects (nodes) shown in FIG. 6 can be extended easily during runtime by further properties and/or values.

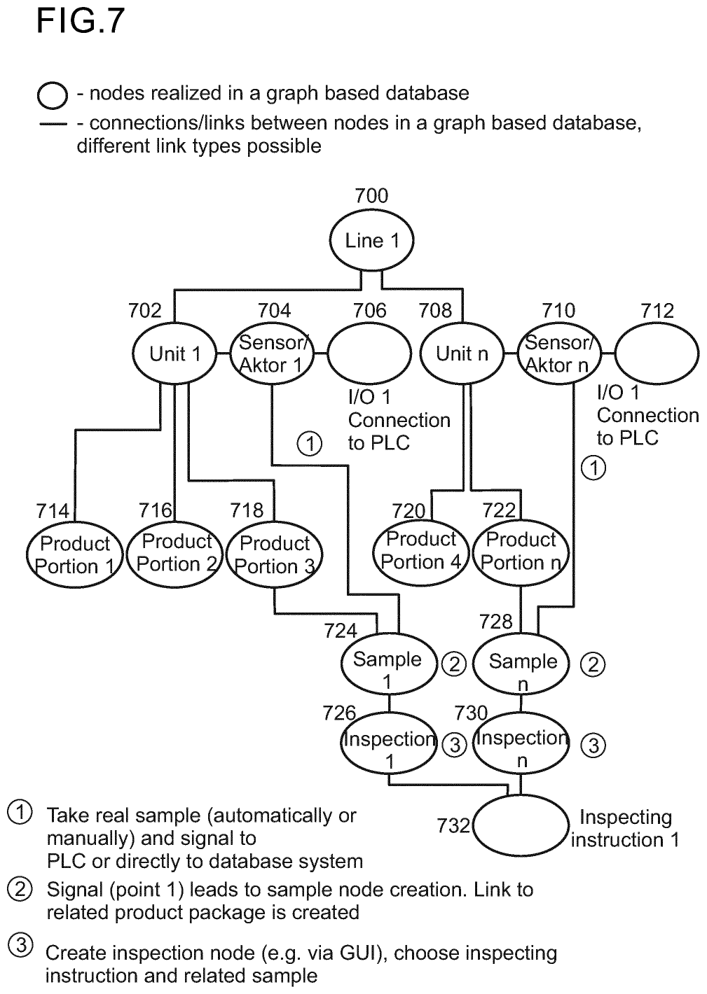

FIG. 7 shows a second embodiment of a graph-based database arrangement as shown in FIG. 6, but only for a production line 700 (“Line 1”).

The equipment devices, in the present embodiment, include material processing units 702 “Unit 1” and “Unit n” 708 which are connected via a signal and/or data connection with sensors/actors “Sensor/Actor 1” 704 and “Sensor/Actor n” 710 which are connected to corresponding input/output (I/O) devices “I/O 1” 706 and “I/O n” 712. These I/O devices comprise a connection to a (not shown) PLC for controlling the operation of the production line 700.

In the present embodiment, the first processing unit (“Unit 1”) 702 is further connected with exemplary three product packages (“Product Portions” 1-3) 714, 716, 718, wherein the second processing unit (“Unit n”) 708 is further connected with further two product packages (“Product Portions” 4 and n) 720, 722. Only exemplarily, product package 3″ 718 is connected to a product sample (“Sample 1”) 724, wherein product package n 722 is connected to another product sample (“Sample n”) 728.

In contrast to the embodiment shown in FIG. 6, the first “Sensor/Actor 1” 704 is also connected to the first product sample (“Sample 1”) 724, wherein the second “Sensor/Actor n” 710 is also connected to the second product sample (Sample n″) 728. These two additional connections have the advantage that it is possible to independently take samples at different sample stations at independent times, or even at the same time. For instance, the sensor/actor 704 can be a push button being arranged at a sample station, which is pressed by a user or operator at the moment when a sample is taken.

Alternatively, such a sample can be a signal that can be generated automatically by a sampling machine. Such an automatically generated signal can e.g. reach the sensor/actor object 704 via the shown I/O object 706, wherein the I/O object 706 receives the mentioned push button information from the (not shown) PLC/DCS. At the moment of taking the sample, the sample object 724 (e.g.) will be created and linked to the product portion located at the sampling station location in that moment.

Based on the accordingly generated samples 724, 728, one or more inspection lots 726, 730 can be generated, even for only one (and the same) sample. However, one or more samples can be generated within one processing line independently, or even at same time.

Finally, like in the embodiment shown in FIG. 6, “Sample 1” 724 is further connected with a first “Inspection unit 1” 726, wherein “Sample n” is further connected with a second “Inspection unit n” 730. Both inspection units 726, 730 are finally connected with an “Inspecting Instruction 1” unit 732 which again serves as a specification, like in the case of the “Inspecting Instruction 1” unit 642 depicted in FIG. 6, namely on how to create a mentioned inspection lot and on how to realize the analysis/quality control of an underlying sample 724, 728. The “Inspecting instruction 1” unit 732 can be created independently, and may be created only once, while using the inspecting instruction 732 for more than only one inspection lot, as illustrated in FIG. 7 by the “Inspection lot 1” 726 and further “Inspection lot n” 730.

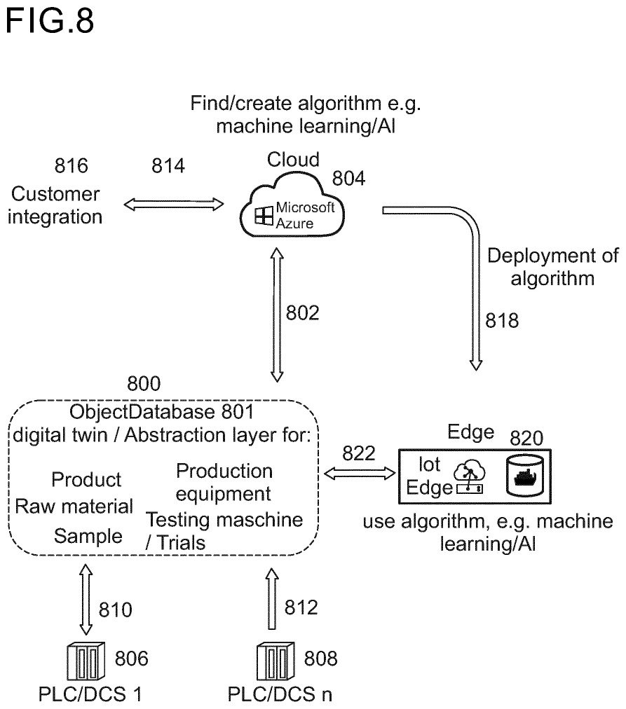

FIG. 8 depicts an abstraction layer 800 which includes an object database 801 and which serves as an abstraction layer for a pre-described production equipment and corresponding raw materials, and for the pre-described product data, maybe including pre-described physical package or product package related data, namely as according digital twins.

The abstraction layer 800, in the present embodiment, provides a bi-directional communication line 802 with an external Cloud computing platform 804. Further, the abstraction layer 800 communicates also with a number of n production PLC/DCS and/or machine PLCs 806, 808, either bidirectionally 810, as in the case of “PLC/DCS 1” 806, or unidirectionally 812, as in the case of “PLC/DCS n” 808. The Cloud computing platform 804, in the present embodiment, comprises a bidirectional communication line 814 to a Customer integration interface or platform 816, via which customers of the present production plant owner can communicate and/or deliver control signals to pre-described equipment units of the plant.

In the object database 801 further included are other objects concerned herewith, e.g. above described samples, inspection lots, sample instructions, sensors/actors, devices, device-related documentation, users (e.g. machine or plant operators), according user groups and user rights, recipes, orders, setpoint-parameter sets, or inbox objects from cloud/edge devices.

At the Cloud computing platform 804, an Artificial Intelligence (AI) or machine learning (ML) system is implemented, by which to find or create an optimum algorithm which is deployed via a dedicated deployment pipeline 818 to an Internet-of-Things (IoT) Edge device or component 820, in order to use an accordingly created or found algorithm for controlling the Edge device 820. The Edge device 820, in the present embodiment, communicates 822 bidirectionally with the abstraction layer 800.

By means of the abstraction layer 800 and the included object database 801, pre-described physical or product packages are created, as described within this document. The abstraction layer 800 can also connect to certain processing and/or AI (or ML) components within the Cloud computing platform 804. For this connection, the known data streaming protocol “Kafka” can be used. Hereby, at or around the time of creation of an underlying product package, first an empty data packet can be sent out as a message, in particular independent of the underlying timeseries data. After that, another message can be sent out when the final product package has been processed. These messages contain the object identifier of the underlying package as data packet ID, so that the relating packets can be linked again with each other on side of the Cloud platform later. This has the advantage that large-size data packets can be avoided for the transmission to the Cloud, thus minimizing the required transmission bandwidth or capacity.

Within the Cloud computing platform 804, the streamed and received product data is used by mentioned AI methods or ML methods in order to find or create algorithms for getting additional data related to an underlying product, such as predicted product quality control (QC) values. For this procedure being performed within the Cloud computing platform 804, additional data like QC data or measured performance parameters of a related product (or physical) package is needed. This can either be received via the same way from the object database 801 in the form of sample objects and inspection lot objects (see also FIG. 6) which contain such information about related product packages.

Such information can also be received from any other systems than the object database. In this case the other system sends the QC and/or performance data together with a sample/inspection lot ID out of the object database. Within Cloud computing platform 804, this data will be combined and used for finding e.g. ML-based algorithms/models. Hereby the computing power within the Cloud platform 804 can be used effectively.

In the present embodiment, the accordingly found algorithms or models are deployed to the Edge device 820 via the deployment pipeline 818. The Edge device 820 can be a component which is located close to the object database 801 of the abstraction layer 800, and thus also close to the PLC/DCS 1 to PLC/DCS n 806, 808 accordingly, namely in terms of a network security level and and location which allows for a low network latency and direct and se-cure communication.

Since, for usage of the ML-model, not such a computing power is needed, the Edge device 820 uses the ML model to generate the mentioned advanced information and provides it to the object database 801. Therefore, the Edge device 820 needs the same information or a subset of the information which is used at the Cloud computing platform 804 to generate the ML-based algorithm or model, the object database 801 can provide this data to the Edge device 820, e.g. via an open network protocol for machine-to-machine communication, like the known “Message Queuing Telemetry Transport” (MQTT) protocol.

This setup enables the realization of an AI/ML-based advanced process control and autonomous manufacturing and according autonomously operating machines.

As illustrated in the embodiment shown in FIG. 8, based on data from a pre-described data object 330-334 (FIG. 3), on side of the Cloud computing platform 804 the AI/ML system or according AI/ML model is trained using such data as training data. The training data, in the present embodiment, thus may comprise historical and current laboratory test data, in particular data from the past, being indicative of the performance parameters of the chemical product.

The AI/ML model can be used for predicting one or more of pre-described performance parameters, said prediction being preferably done via the computing unit. Additionally, or alternatively, the AI/ML model can be used for least partially controlling the production process, preferably via adjusting the equipment operating conditions, and more preferably said controlling being done via the mentioned computing unit. Additionally, or alternatively, the AI/ML model can also be used, e.g., by the computing unit, for determining which of the process parameters and/or equipment operating conditions have a dominant effect on the chemical product, such that those dominant of the process parameters and/or equipment operating conditions are appended to the data object, or the mentioned object identifier, respectively.

Those skilled in the art will appreciate that the method steps, at least those which are performed via the computing unit may be performed in a “real-time” or near real-time manner. The terms are understood in the technical field of computers. As a specific example, a time delay between any two steps performed by the computing unit is no more than 15 s, specifically of no more than 10 s, more specifically of no more than 5 s. Preferably, the delay is less than a second, more preferably, less than a couple of milliseconds. Accordingly, the computing unit may be configured to perform the method steps in a real-time manner. Moreover, the software product may cause the computing unit to perform the method steps in a real-time manner.

The method steps may be performed, for example, in the order as shown listed in the examples or aspects. It shall be noted, however, that, under specific circumstances, a different order may also be possible. Further, it is also possible to perform one or more of the method steps once or repeatedly. The steps may be repeated at regular or irregular time periods. Further, it is possible to perform two or more of the method steps simultaneously or in a timely overlapping fashion, specifically when some or more of the method steps are performed repeatedly. The method may comprise further steps which are not listed.

The word “comprising” does not exclude other elements or steps, and the indefinite article “a” or “an” does not exclude a plurality. A single processing means, processor or controller or other similar unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

Further, it shall be noted that in the present disclosure, the terms “at least one”, “one or more” or similar expressions indicating that a feature or element may be present once or more than once typically may have been used only once when introducing the respective feature or element. Thus, in some cases unless specifically stated otherwise, when referring to the respective feature or element, the expressions “at least one” or “one or more” may not have been repeated, non-withstanding the fact that the respective feature or element may be present once or more than once.

Further, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The present teachings may, as the skilled person will recognize, be performed by using alternative features. Similarly, features introduced by “according to an aspect” or similar expressions are intended to be optional features, without any restriction regarding alternatives of the present teachings, without any restrictions regarding the scope of the present teachings and without any restriction regarding the possibility of combining the features introduced in such way with other optional or non-optional features of the present teachings.

Various examples have been disclosed above for a method for monitoring a production process; a system for carrying out the method herein disclosed; a system for controlling a production process; a use; a software program; and a computing unit comprising the computer program code for carrying out the method herein disclosed. More specifically, the present teachings relate to a method for controlling a production process comprising: providing an upstream object identifier comprising input material data and at least one desired performance parameter related to the chemical product; determining a set of process and/or operation parameters based on the upstream object identifier and the at least one desired performance parameter; determining zone-specific control settings for each of the equipment zones based on the determined set of process and/or operation parameters and historical data; providing the zone-specific control settings for controlling the production of the chemical product related to the upstream object identifier. The present teachings also relate to a system for controlling a production process, a use of the control settings, and a software product for implementing the method steps disclosed herein. Those skilled in the art will understand however that changes and modifications may be made to those examples without departing from the spirit and scope of the accompanying claims and their equivalents. It will further be appreciated that aspects from the method and product embodiments discussed herein may be freely combined.

Summarizing and without excluding further possible embodiments, certain example embodiments of the present teachings are summarized in the following clauses:

Clause 1. A method for controlling a production process for manufacturing a chemical product at an industrial plant, the industrial plant comprising a plurality of physically separated equipment zones, and the product being manufactured by processing, via the plurality equipment zones, at least one input material using the production process, the method at least partially being performed via a computing unit, which method comprises:
providing, via an interface, an upstream object identifier comprising input material data and at least one desired performance parameter related to the chemical product; wherein the input material data is indicative of one or more properties of the input material,
determining, via the computing unit, a set of process and/or operation parameters based on the upstream object identifier and the at least one desired performance parameter;
determining, via the computing unit, zone-specific control settings for each of the equipment zones based on the determined set of process and/or operation parameters and historical data;
providing, via an output interface, the zone-specific control settings for controlling the production of the chemical product related to the upstream object identifier.

Clause 2. The method of clause 1, wherein the historical data comprise data from one or more historical upstream object identifiers related to previously processed input material, and wherein at least one of the historical upstream object identifiers is appended with at least a part of that process data which is indicative of the process parameters and/or equipment operating conditions that the previously processed input material was processed under, for example, in or at the upstream equipment zone.

Clause 3. The method of any one or more of clause 1-clause 2, wherein the method also comprises:
executing, using the zone-specific control settings, the production process, preferably by providing the zone-specific control settings automatically to the plant control system.

Clause 4. The method of any one or more of clause 1-clause 3, wherein the output interface is the same component as the interface.

Clause 5. The method of any one or more of clause 1-clause 4, wherein the output interface and the interface are different components.

Clause 6. The method of any one or more of clause 1-clause 5, wherein the method further comprises:
receiving, at the computing unit, real-time process data from one or more of the equipment zones; wherein the real-time process data comprises real-time process parameters and/or equipment operating conditions.

Clause 7. The method of clause 6, wherein the method comprises:
determining, via the computing unit, a subset of the real-time process data based on the upstream object identifier and a zone presence signal; wherein the zone presence signal indicates presence of the input material at a specific equipment zone during the production process.

Clause 8. The method of clause 7, wherein the method also comprises:
appending, to the upstream object identifier, the subset of the real-time process data and/or data from an enterprise resource planning (“ERP”) system.

Clause 9. The method of clause 7 or clause 8, wherein the method comprises:
computing, via the computing unit, at least one zone-specific performance parameter of the chemical product related to the upstream object identifier based on the subset of the real-time process data and the historical data, preferably the at least one zone-specific performance parameter being appended to the upstream object identifier.

Clause 10. The method of any one or more of clause 7-clause 9, wherein the zone presence signal is generated via the computing unit by performing a zone-time transformation, which transformation maps at least one property related to the input material to the specific equipment zone, such as via one or more time-dependent signals from the real-time process data.

Clause 11. The method of any one or more of clause 9-clause 10, wherein the method comprises:
controlling, via the computing unit, the production process such that the difference between at least one of the zone-specific performance parameters and their respective associated value of the desired performance parameter is minimized.

Clause 12. The method of any one or more of clause 9-clause 11, wherein the computing of at least one zone-specific performance parameter is performed at least partially using at least one machine learning (“ML”) model trained using the historical data.

Clause 13. The method of clause 12, wherein the ML model is configured to provide at least one confidence value indicative of the confidence level for the computation of at least one zone-specific performance parameter.

Clause 14. The method of clause 13, wherein a warning signal is generated, preferably at a control system for the production process, in response to the confidence level of the computation or prediction of the at least zone zone-specific performance parameter falling below an accuracy threshold value.

Clause 15. The method of clause 13 or clause 14, wherein a sampling object identifier is automatically generated in response to the confidence level of the computation or prediction of the at least zone zone-specific performance parameter falling below an accuracy threshold value or in response to the warning signal, the sampling object identifier being related to the material which is at that respective zone at or around the time when the confidence level accuracy crossed the accuracy value.

Clause 16. The method of clause 14 or clause 15, wherein at least one lab analysis is performed in response to the warning signal, preferably the analysis being performed on the material which is at that respective zone related to the warning.

Clause 17. The method of clause 16, wherein the date and/or results of the analysis is appended to the sampling object identifier, preferably data from the sampling object identifier being included in the historical data for future computation by the computing unit.

Clause 18. The method of any one or more of clause 7-clause 17, wherein the plurality of physically separated equipment zones also comprises a downstream equipment zone such that during the production process the input material traverses from the upstream equipment zone to the downstream equipment, and wherein the method also comprises:
providing, via the interface, a downstream object identifier comprising at least a part of the upstream object identifier;
determining, via the computing unit, an another subset of the real-time process data based on the downstream object identifier and the zone presence signal;
determining, via the computing unit, further zone-specific control settings for at least the downstream equipment zone based on data from the upstream object identifier, the another subset of the real-time process data and another historical data,
   preferably the another historical data comprising data from one or more historical downstream object identifiers related to previously processed input material in the downstream equipment zone, and further preferably, at least one historical downstream object identifier being appended with at least a part of the process data which is indicative of the process parameters and/or equipment operating conditions that the previously processed input material was processed under, for example, in the downstream equipment zone.

Clause 19. The method of clause 18, wherein the method also comprises:
computing, via the computing unit, another at least one zone-specific performance parameter of the chemical product related to the downstream object identifier based on the another subset of the real-time process data and the another historical data.
appending, to the downstream object identifier, the another at least one zone-specific performance parameter.

Clause 20. The method of clause 18 or clause 19, wherein the method also comprises:
appending, to the downstream object identifier, at least a part of the another subset of the real-time process data.

Clause 21. The method of any one or more of clause 1-clause 20, wherein any of the object identifiers are provided at a memory storage operatively coupled to the computing unit.

Clause 22. The method of clause 21, wherein the computing unit and/or the memory storage are at least partially implemented via a cloud-based service.

Clause 23. The method of any one or more of clause 1-clause 22, wherein the chemical product is any one or their combinations of a, chemical, pharmaceutical, nutritional, cosmetic, or biological product.

Clause 24. The method of any one or more of clause 1-clause 23, wherein the chemical product is in solid, semi-solid, paste, liquid, emulsion, solution, pellets, granules, or powder form.

Clause 25. The method of any one or more of clause 1-clause 22, wherein the chemical product is a thermoplastic polyurethane (“TPU”), or more specifically an expanded TPU.

Clause 26. The method of clause 1 or clause 25, wherein the input material is methylene diphenyl diisocyanate (“MDI”) and/or polytetrahydrofuran (“PTHF”).

Clause 27. The method of any one or more of clause 1-clause 26, wherein the any of the equipment zones comprise any one or more components such as, a transport element such as a conveyor system, a heat exchanger such as a heater, a furnace, a cooling unit, a reactor, a mixer, a miller, a chopper, a compressor, a slicer, an extruder, a distilling unit, an extractor, a dryer, a sprayer, a pressure or vacuum chamber, a tube, a bin, a silo, an octabin or any other kind of apparatus which is used directly or indirectly for or during the production process at the industrial plant, more preferably, such apparatuses and/or components which have influence on the performance of the chemical product.

Clause 28. The method of any one or more of clause 1-clause 27, wherein the production process is at least partially a batch production process.

Clause 29. The method of any one or more of clause 1-clause 28, wherein the production process is at least partially a campaign production process.

Clause 30. The method of any one or more of clause 1-clause 29, wherein the production process is at least partially a continuous production process.

Clause 31. The method of any one or more of clause 1-clause 30, wherein the equipment operating conditions are any characteristics or values that represent the state of the equipment, for example, any one or more of, setpoint, controller output, production sequence, calibration status, any equipment related warning, vibration measurement, speed such as transport element speed, temperature and fouling value such as filter differential pressure, maintenance date.

Clause 32. The method of any one or more of clause 1-clause 31, wherein the process data comprise at least one numerical value indicative of the process parameters and/or equipment operating conditions measured during the production process.

Clause 33. The method of any one or more of clause 1-clause 32, wherein the process data comprise at least one binary value indicative of the process parameters and/or equipment operating conditions measured or detected during the production process.

Clause 34. The method of any one or more of clause 1-clause 33, wherein the process data comprise time-series data of one or more of the process parameters and/or the equipment operating conditions.

Clause 35. The method of any one or more of clause 1-clause 34, wherein the process data comprise temporal information of the process parameters and/or the equipment operating conditions, or the time-series data.

Clause 36. The method of clause 35, wherein the temporal information is in the form of the data indicating time stamps for at least some of the data points related to the process parameters and/or the equipment operating conditions, or the time-series data.

Clause 37. The method of any one or more of clause 1-clause 36, wherein the input material is at least one feedstock or unprocessed material that is used for producing the chemical product.

Clause 38. The method of any one or more of clause 1-clause 37, wherein the input material is any organic or inorganic substance or their combination comprising a plurality of organic and/or inorganic components in any form.

Clause 39. The method of any one or more of clause 1-clause 38, wherein the input material data comprise data related to, or indicative of, one or more characteristics or properties of the input material.

Clause 40. The method of any one or more of clause 1-clause 39, wherein the input material data comprise lab sample or test data related to the input material, such as historical test results.

Clause 41. The method of any one or more of clause 1-clause 40, wherein the input material data comprise values indicative of physical and/or chemical characteristics of the input material, such as any one or more of, density, concentration, purity, pH, composition, viscosity, temperature, weight, volume, and/or performance data related to the input material.

Clause 42. The method of any one or more of clause 32-clause 41, wherein the at least one numerical value and/or the at least one binary value and/or the time-series data and/or at least some of the values indicative of physical and/or chemical characteristics of the input material are at least partially obtained or measured via signals from one or more sensors and/or switches operatively coupled to the equipment, preferably said sensors and/or switches being a part of the equipment.

Clause 43. The method of any one or more of clause 1-clause 42, wherein the object identifier is provided via a computing unit operatively coupled to the equipment zones, preferably said computing unit being a part of the equipment.

Clause 44. The method of clause 43, wherein the computing unit is, or it is a part of, a controller or a control system, such as a distributed control system (“DCS”) and/or a programmable logic controller (“PLC”).

Clause 45. The method of any one or more of clause 1-clause 44, wherein the object identifier is provided or is generated in response to a trigger event or signal, said event or signal preferably being provided via the equipment, more preferably in response to output of any of the one or more sensors and/or switches operatively coupled to the equipment.

Clause 46. The method of clause 45, wherein the trigger event or signal relates to a quantity value of the input material, more specifically, to an occurrence of the quantity value reaching or meeting a predetermined quantity threshold value, and said occurrence being detected via the computing unit and/or the equipment.

Clause 47. The method of clause 46, wherein the quantity value is a weight value and/or a fill factor and/or a level value and/or a volume value.

Clause 48. The method of any one or more of clause 43-clause 47, wherein the equipment is also operatively coupled to one or more actuators and/or end effector units, preferably said actuators and/or end effector units being a part of the equipment.

Clause 49. The method of any one or more of clause 1-clause 48, wherein any or each of the object identifiers includes a unique identifier, preferably a globally unique identifier (“GUID”).

Clause 50. The method of any one or more of clause 18-clause 49, wherein any or each of the equipment zones are monitored and/or controlled via an individual ML model, the individual ML model being trained based on data from the respective object identifier from that zone.

Clause 51. A system for monitoring system for controlling a production process for manufacturing a chemical product at an industrial plant, the industrial plant comprising a plurality of physically separated equipment zones, and the product being manufactured by processing, via the plurality equipment zones, at least one input material using the production process, the system being configured such to perform the method steps according to any of the above method clauses.

Clause 52. A computer program, or a non-transitory computer readable medium storing the program, comprising instructions which, when the program is executed by a suitable computing unit, cause the computing unit to carry out the method steps of any of the above method clauses.

Clause 53. A system for controlling a production process for manufacturing a chemical product at an industrial plant, the industrial plant comprising a computing unit and a plurality of physically separated equipment zones, and the product being manufactured by processing, via the plurality equipment zones, at least one input material using the production process, wherein the system is configured to:
provide, via an interface, an upstream object identifier comprising input material data and at least one desired performance parameter related to the chemical product; wherein the input material data is indicative of one or more properties of the input material,
determine, via the computing unit, a set of process and/or operation parameters based on the upstream object identifier and the at least one desired performance parameter;
determine, via the computing unit, zone-specific control settings for each of the equipment zones based on the determined set of process and/or operation parameters and historical data;
provide, via an output interface, the zone-specific control settings for controlling the production of the chemical product related to the upstream object identifier.

Clause 54. A computer program, or a non-transitory computer readable medium storing the program, comprising instructions which, when the program is executed by a suitable computing unit, operatively coupled to a plurality of for equipment zones for manufacturing a chemical product at an industrial plant by processing least one input material using a production process, causes the computing unit to:
provide, via an interface, an upstream object identifier comprising input material data and at least one desired performance parameter related to the chemical product; wherein the input material data is indicative of one or more properties of the input material,
determine a set of process and/or operation parameters based on the upstream object identifier and the at least one desired performance parameter;
determine zone-specific control settings for each of the equipment zones based on the determined set of process and/or operation parameters and historical data;
provide, via an output interface, the zone-specific control settings for controlling the production of the chemical product related to the upstream object identifier.

Clause 55. Use of the zone-specific control settings as generated in any one or more of clause 1-clause 50 for controlling a production process of an industrial plant.

1. A method for controlling a production process for manufacturing a chemical product at an industrial plant, the industrial plant comprising a plurality of physically separated equipment zones, and the product being manufactured by processing, via the plurality equipment zones, at least one input material using the production process, the method at least partially being performed via a computing unit, the method comprises:
providing, via an interface, an upstream object identifier comprising input material data and at least one desired performance parameter related to the chemical product; wherein the input material data is indicative of one or more properties of the input material,
determining, via the computing unit, a set of process and/or operation parameters based on the upstream object identifier and the at least one desired performance parameter;
determining, via the computing unit, zone-specific control settings for each of the equipment zones based on the determined set of process and/or operation parameters and historical data;
providing, via an output interface, the zone-specific control settings for controlling the production of the chemical product related to the upstream object identifier.

2. The method of claim 1, wherein the historical data comprise data from one or more historical upstream object identifiers related to previously processed input material, and wherein at least one of the historical upstream object identifiers is appended with at least a part of that process data which is indicative of the process parameters and/or equipment operating conditions that the previously processed input material was processed under.

3. The method of claim 1, wherein the method further comprises:
executing, using the zone-specific control settings, the production process.

4. The method of claim 1, wherein the method further comprises:
receiving, at the computing unit, real-time process data from one or more of the equipment zones; wherein the real-time process data comprises real-time process parameters and/or equipment operating conditions.

5. The method of claim 4, wherein the method comprises:
determining, via the computing unit, a subset of the real-time process data based on the upstream object identifier and a zone presence signal; wherein the zone presence signal indicates presence of the input material at a specific equipment zone during the production process.

6. The method of claim 5, wherein the method further comprises:
appending, to the upstream object identifier, the subset of the real-time process data.

7. The method of claim 5, wherein the method comprises:
computing, via the computing unit, at least one zone-specific performance parameter of the chemical product related to the upstream object identifier based on the subset of the real-time process data and the historical data, preferably the at least one zone-specific performance parameter being appended to the upstream object identifier.

8. The method of claim 5, wherein the zone presence signal is generated via the computing unit by performing a zone-time transformation, which transformation maps at least one property related to the input material to the specific equipment zone, such as via one or more time-dependent signals from the real-time process data.

9. The method of claim 7, wherein the method comprises:
controlling, via the computing unit, the production process such that the difference between at least one of the zone-specific performance parameters and their respective associated value of the desired performance parameter is minimized.

10. The method of claim 7, wherein the computing of at least one zone-specific performance parameter is performed at least partially using at least one machine learning (“ML”) model trained with the historical data.

11. The method of claim 5, wherein the plurality of physically separated equipment zones also comprises a downstream equipment zone such that during the production process the input material traverses from the upstream equipment zone to the downstream equipment, and wherein the method further comprises:
providing, via the interface, a downstream object identifier comprising at least a part of the upstream object identifier;
determining, via the computing unit, an another subset of the real-time process data based on the downstream object identifier and the zone presence signal;
determining, via the computing unit, further zone-specific control settings for at least the downstream equipment zone based on data from the upstream object identifier, the another subset of the real-time process data and another historical data.

12. The method of claim 11, wherein the method further comprises:
computing, via the computing unit, another at least one zone-specific performance parameter of the chemical product related to the downstream object identifier based on the another subset of the real-time process data and the another historical data;
appending, to the downstream object identifier, the another at least one zone-specific performance parameter.

13. The method of claim 11, wherein the method further comprises:
appending, to the downstream object identifier, at least a part of the another subset of the real-time process data.

14. A system for controlling a production process for manufacturing a chemical product at an industrial plant, the industrial plant comprising a plurality of physically separated equipment zones, and the product being manufactured by processing, via the plurality equipment zones, at least one input material using the production process, wherein the system is configured to:
provide, via an interface, an upstream object identifier comprising input material data and at least one desired performance parameter related to the chemical product; wherein the input material data is indicative of one or more properties of the input material,
determine, via the computing unit, a set of process and/or operation parameters based on the upstream object identifier and the at least one desired performance parameter;
determine, via the computing unit, zone-specific control settings for each of the equipment zones based on the determined set of process and/or operation parameters and historical data,
provide, via an output interface, the zone-specific control settings for controlling the production of the chemical product related to the upstream object identifier.

15. A computer program, or a non-transitory computer readable medium storing the program, comprising instructions which, when the program is executed by a suitable computing unit, operatively coupled to a plurality of for equipment zones for manufacturing a chemical product at an industrial plant by processing least one input material using a production process, causes the computing unit to:
provide, via an interface, an upstream object identifier comprising input material data and at least one desired performance parameter related to the chemical product; wherein the input material data is indicative of one or more properties of the input material,
determine a set of process and/or operation parameters based on the upstream object identifier and the at least one desired performance parameter;
determine zone-specific control settings for each of the equipment zones based on the determined set of process and/or operation parameters and historical data,
provide, via an output interface, the zone-specific control settings for controlling the production of the chemical product related to the upstream object identifier.

16. (canceled)
